(19) United States
(12) Patent Application Publication
(10) Pub. No.: US 2025/0056372 A1
(43) Pub. Date: Feb. 13, 2025

(54) METHOD, APPARATUS AND SYSTEM FOR MANAGING NETWORK RESOURCES

(71) Applicant: HUAWEI TECHNOLOGIES CO., LTD., SHENZHEN (CN)

(72) Inventors: Weisen SHI, Kanata (CA); Hang ZHANG, Kanata (CA); Ming JIA, Kanata (CA)

(73) Assignee: HUAWEI TECHNOLOGIES CO., LTD., SHENZHEN (CN)

(21) Appl. No.: 18/930,504

(22) Filed: Oct. 29, 2024

Related U.S. Application Data
(63) Continuation of application No. PCT/CN2022/093625, filed on May 18, 2022.

(51) Int. Cl. H04W 40/20

(52) U.S. Cl. CPC H04W 40/20

(57) ABSTRACT

A method and apparatus for managing network resources in a location based multiple access (LOMA) radio access network is provided. The method includes receiving traffic data and signal-to-noise (SNR) data from one or more LOMA wireless entities associated with the LOMA RAN, generating training data based on the received traffic data and SNR data and storing the training data, generating or updating a multi-layer LOMA map based on the training data, the multi-layer LOMA map including multiple layers, each layer including one or more LOMA zones, and each LOMA zone in an upper layer of the multi-layer LOMA map associated with one or more LOMA zones in a lower layer of the multi-layer LOMA map and transmitting the generated or updated multi-layer LOMA map to the one or more LOMA wireless entities. There is also provided methods for downlink and uplink data transmissions enabled by a multi-layer LOMA map.

### CROSS-REFERENCE TO RELATED APPLICATION

This application is a continuation of International Application No. PCT/CN2022/093625, filed on May 18, 2022, the disclosure of which is hereby incorporated by reference in its entirety.

### TECHNICAL FIELD

The present disclosure pertains to the field of wireless network and in particular to a method and apparatus for managing network resources, for example, for data transmission in a location based multiple access (LOMA) radio access network (RAN).

### BACKGROUND

Present day wireless network topology can be characterized as ‘cell centric’ and is organized by base stations which provide network coverage over a geographic area. Multiple base stations may exist in a particular area and a network of cellular base stations may provide coverage over a wide geographic area. Base stations handle a variety of wireless traffic including voice and data that have different traffic patterns and requirements.

However, using the present cell centric approach, it can be difficult to efficiently manage network resources in the evolving future networks such as 6G radio access network (RAN). The irregular deployment of RAN infrastructures (e.g. cellular cells, access points) with heterogeneous radio access technologies increases the complexity of radio resource planning and management. It will likely be difficult to handle such complex resource planning and management using existing spectrum reuse and inter-cell interference coordination (ICIC) solutions. Moreover, complexity of RAN resource sharing and scheduling can be increased due to various services supported by RAN with diversified traffic patterns and quality of service (QoS) requirements. In particular, the increasing number of short and bursty packets, such as Internet-of-Things (IoT) and artificial intelligence (AI) based services, may require complex scheduling algorithms and therefore potentially create massive and frequent signaling overheads between user equipments (UEs) and RAN.

To resolve these problems, new technologies such as map-based radio access network (RAN) access technologies have been proposed. However, existing technologies still face challenges.

One of the challenges faced by the related prior art is a low resource utilization ratio. In the prior art, radio resources are statically allocated to specific locations or geographical areas. Furthermore, statistical data traffic models and fixed radio resource units are applied to radio resource scheduling/access algorithms in downlink/uplink data transmissions. Therefore, the resource utilization is highly limited.

Another challenge is that the systems and methods to generate any maps in existing technologies are model based, and such model based systems and methods cannot be utilized in complex wireless environments (e.g. a RAN with dense and unevenly distributed infrastructures and blockage buildings).

Therefore there is a need for a method and apparatus for managing network resources for data transmission in a location based multiple access (LOMA) radio access network (RAN), that is not subject to one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide a method, apparatus and system for managing network resources, for example in a location based multiple access (LOMA) radio access network. In accordance with embodiments of the present disclosure, there is provided a method for managing network resources for data transmission. The method includes receiving traffic data and signal-to-noise (SNR) data from one or more LOMA wireless entities associated with a location based multiple access (LOMA) radio access network (RAN) and generating training data based on the received traffic data and SNR data. The method further includes generating or updating a multi-layer LOMA map based on the training data, the multi-layer LOMA map including multiple layers, each layer including one or more LOMA zones, and each LOMA zone in an upper layer of the multi-layer LOMA map associated with one or more LOMA zones in a lower layer of the multi-layer LOMA map. The method additionally includes transmitting the generated or updated multi-layer LOMA map to the one or more wireless entities.

In some embodiments, each LOMA zone is associated with one or more LOMA parameters and wherein the one or more LOMA parameters associated with a LOMA zone in an upper layer of the multi-layer LOMA map are sharable with one or more LOMA zones in a lower layer of the multi-layer LOMA map.

A technical advantage of embodiments may be that a multi-layer LOMA zone configuration may be provided to decouple the resources and MCS mapping to specific locations thereby enabling flexible resource sharing.

In some embodiments, a radio resource set is allocated to a particular LOMA zone are based on one or more of network data traffic distributions and wireless channel states, wherein the radio resource set allocated to a LOMA zone in an upper layer of the multi-layer LOMA map are sharable with one or more LOMA zones in a lower layer of the multi-layer LOMA map that are associated with LOMA zone in the upper layer.

In some embodiments, the method further includes monitoring for a variation of the training data indicative of traffic data and a channel state distribution dataset and if the variation exceeds a predetermined threshold, initiating updating of the multi-layer LOMA map.

In some embodiments, before generating or updating the multi-layer LOMA map, the method further includes determining a size and a shape of each LOMA zone in an upper layer and LOMA parameters associated with each LOMA zone in the upper layer based on the uplink or downlink channel state distribution data and the uplink/downlink spatial traffic distribution data. Generating or updating the multi-layer LOMA map further includes determining a size and a shape of each LOMA zone in a lower layer and LOMA parameters associated with each LOMA zone in the lower layer based on the uplink/downlink channel state distribution data, the uplink/downlink spatial traffic distribution data, the determined size and shape of each LOMA zone in the upper layer, and the determined LOMA parameters associated with each LOMA zone in the upper layer. In addition, the generating or updating the multi-layer LOMA map further includes determining types and amounts of resource units (RUs) based on the determined size and shape of each LOMA zone, the determined LOMA parameters associated with each LOMA zone, and uplink/downlink temporal traffic distribution data and generating or updating the multi-layer LOMA map based on the RU types and amounts.

A technical advantage of embodiments may be that through the use of dynamic RUs, simpler RU scheduling and access algorithms can be applied in a LOMA RAN.

In some embodiments, the determining the types and amounts of RUs includes determining intermediate RU types and amounts based on performance feedback of one or more of a predetermined RU scheduling algorithm and a predetermined RU access algorithm and determining the RU types and amounts based further on the intermediate RU types and amounts.

In accordance with embodiments of the present disclosure, there is provided a method for uplink data transmission. The method includes selecting, by a user equipment (UE), one or more resource units (RUs) for data transmission at least in part based on a multi-layer location based multiple access (LOMA) map, the multi-layer LOMA map at least in part defining a modulation and coding scheme (MCS) associated with the UE. The method further includes transmitting, by the UE, uplink data using the one or more selected RUs.

In some embodiments, the method further includes receiving, by the user equipment (UE), an identifier associated with the uplink data transmission, the identifier indicative of a desired retransmission of the uplink data. In some embodiments, where two or more MCSs are associated with the UE, the uplink data transmission further includes a selection of the MCS.

In accordance with embodiments of the present disclosure, there is provided a method downlink data transmission. The method includes selecting, by an infrastructure, one or more resource units (RUs) for data transmission at least in part based on a multi-layer location based multiple access (LOMA) map, the multi-layer LOMA map at least in part defining a modulation and coding scheme (MCS) associated with a target UE. The method further includes transmitting, by the infrastructure, the downlink data using the one or more selected RUs.

In some embodiments, the method further includes receiving, by the infrastructure, an identifier associated with the downlink data transmission, the identifier indicative of a desired retransmission of the uplink data.

In accordance with embodiments of the present disclosure, there is provided an apparatus including one or more processors coupled with a memory storing instructions which when executed by the one or more processors cause the apparatus to perform one or more of the above methods.

In accordance with embodiments of the present disclosure, there is provided a computer readable medium storing instructions which when executed by one or more processors cause the one or more processors to perform one or more of the above methods.

In accordance with embodiments of the present disclosure, there is provided a communication system including an apparatus and one or more wireless entities. The apparatus is configured to receive traffic data and signal-to-noise (SNR) data from the one or more wireless entities associated with a location based multiple access (LOMA) radio access network (RAN) and generate training data based on the received traffic data and SNR data. The apparatus is further configured to generate or update a multi-layer LOMA map based on the training data, the multi-layer LOMA map including multiple layers, each layer including one or more LOMA zones, and, each LOMA zone in an upper layer of the multi-layer LOMA map associated with one or more LOMA zones in a lower layer of the multi-layer LOMA map and transmit the generated or updated multi-layer LOMA map to the one or more wireless entities. The one or more wireless entities is configured to transmit the traffic data and SNR data and receive the generated or updated multi-layer LOMA map.

In some embodiments, at least one of the one or more wireless entities is configured to select one or more resource units (RUs) for data transmission at least in part based on the LOMA map, the multi-layer LOMA map at least in part defining a modulation and coding scheme (MCS) associated with the UE and transmit uplink data using the one or more selected RUs.

In some embodiments, the communication system further includes an infrastructure configured to select one or more resource units (RUs) for data transmission at least in part based on the LOMA map, the multi-layer LOMA map at least in part defining a modulation and coding scheme (MCS) associated with a target UE. The infrastructure is further configured to transmit a downlink control message indicating the one or more wireless entities with the selected RU information and transmit the downlink data using the one or more selected RUs.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which:

FIG. 1 illustrates resource units (RUs) in a location based multiple access (LOMA) MAP, in accordance with embodiments of the present disclosure.

FIG. 2 illustrates a zone in a LOMA MAP defined by vertex LOMA MAP tiles (Tiles) and lines connecting the vertex Tiles, in accordance with embodiments of the present disclosure.

FIG. 3 illustrates a two-layer downlink LOMA MAP for a LOMA radio access network (RAN) with three infrastructures equipped with omnidirectional antennas, in accordance with embodiments of the present disclosure.

FIG. 4 illustrates a one-layer uplink LOMA MAP for a LOMA RAN with three infrastructures equipped with omnidirectional antennas, in accordance with embodiments of the present disclosure.

FIG. 5 illustrates a multi-layer LOMA MAP format, in accordance with embodiments of the present disclosure.

FIG. 6 illustrates a RU information section for a zone in a multi-layer LOMA MAP, in accordance with embodiments of the present disclosure.

FIG. 7 illustrates a LOMA controller architecture, in accordance with embodiments of the present disclosure.

FIG. 8 illustrates a procedure for uploading data locally collected by LOMA wireless entities to a LOMA controller, in accordance with embodiments of the present disclosure.

FIG. 9 illustrates a procedure for initial delivery of LOMA MAP(s) to a new UE which accesses a LOMA RAN for the first time, in accordance with embodiments of the present disclosure.

FIG. 10 illustrates a procedure for updating a LOMA MAP triggered by a LOMA controller, in accordance with embodiments of the present disclosure.

FIG. 11 illustrates a procedure for updating the location of a UE to associated infrastructure, in accordance with embodiments of the present disclosure.

FIG. 12 illustrates a procedure for a LOMA MAP enabled downlink data transmission, in accordance with embodiments of the present disclosure.

FIG. 13 illustrates a procedure for a LOMA MAP enabled downlink data re-transmission, in accordance with embodiments of the present disclosure.

FIG. 14 illustrates a procedure for a LOMA MAP enabled uplink data transmission, in accordance with embodiments of the present disclosure.

FIG. 15 illustrates a transmit power (TP) control procedure for a LOMA MAP enabled uplink data transmission, in accordance with embodiments of the present disclosure.

FIG. 16 illustrates a method for managing network resources for data transmission in a LOMA RAN, in accordance with embodiments of the present disclosure.

FIG. 17 is a schematic structural diagram of a system architecture according to an embodiment of the present disclosure.

FIG. 18 is a structural hardware diagram of a chip according to an embodiment of the present disclosure.

FIG. 19 illustrates a schematic diagram of a hardware structure of a training apparatus according to an embodiment of the present disclosure.

FIG. 20 illustrates a schematic diagram of a hardware structure of an execution apparatus according to an embodiment of the present disclosure.

FIG. 21 illustrates a system architecture according to an embodiment of the present disclosure.

FIG. 22 is a schematic structural diagram of a recurrent neural network (RNN) according to embodiments of the present disclosure

It will be noted that throughout the appended drawings, like features are identified by like reference numerals.

### DETAILED DESCRIPTION

In the present disclosure, location based multiple access (LOMA) refers to a resource management method or approach that utilizes location information of wireless entities (also called as LOMA wireless entities) to facilitate wireless resource management and control. The location information may be provided in two or three dimensions. The LOMA approach includes a joint semi-static resource management and dynamic autonomous resource access technology.

In the present disclosure, a LOMA wireless entity refers to a physical or virtualized network node (e.g. base station, sensor, relay, road side entity, etc.) or a user equipment (UE) (e.g. handset, sensor, vehicles, drone or other terminal devices, etc.). It is noted that a network node may be network infrastructure deployed as network nodes which communicate with UEs and can typically be fixed in location. A LOMA wireless entity is capable of wirelessly transmitting and receiving data, and requires wireless network resources to carry out uplink and downlink data transmissions or communicate with other network entities.

In the present disclosure, LOMA radio access network (RAN) refers to a type of RAN in which the uplink or downlink data transmissions are enabled and controlled according to LOMA map(s) stored in LOMA wireless entities. A LOMA RAN may be a physical RAN or a virtualized RAN slice for a physical RAN. A LOMA RAN may include all existing network functions and a LOMA controller. A LOMA controller is configured to manage generation, update and distribution of LOMA MAPs. A network operator that operates a LOMA RAN is referred to as LOMA RAN operator.

In the present disclosure, MAP refers to a wireless network access map.

The present disclosure is related to a location-based method for network management that utilizes location information available from wireless entities for resource management and control.

Some MAP-based methods for wireless network access can provide solutions to challenges, for example those illustrated above, that may be faced by resource management in 6G RAN. Specifically, some MAP-based methods, by virtue of the precise positioning technique, are provided to simplify the procedure for the UE's access to the RAN. For example, a system and method for configuration of a wireless network access map and applications that include the concept of a wireless network access map (MAP) so that a UE can speed up the network discovery and radio connection establishment can be provided. As another example, a system and method for reduced network signaling based on mapping (aMAP) that can speed up downlink synchronization and uplink transmission can be provided. However, both of the MAP and aMAP do not associate communication resources and modulation and coding scheme (MCS) with geo-locations. Further, both of the MAP and aMAP are designed only for UEs (e.g. handset, sensor, vehicles, drone or other terminal devices, etc.) but not for network infrastructures (e.g. base station, sensor, relay, road side entity, etc.).

LOMA is provided to solve the same challenges. To realize LOMA, techniques like a precise positioning technique and an artificial intelligence (AI) technique can be required. A precise positioning technique can be used to determine a (precise) location of a UE. For example, GPS with an error range of about one meter may be used to acquire the essentially exact location of a UE. An AI technique may be used to address the complexity of interference and resource management in a 6G RAN among other RAN configurations.

A LOMA MAP associates RAN resources with geo-locations of UEs and network infrastructures, and use LOMA MAP(s) to guide the resource management of a RAN. Currently, a LOMA MAP is a one-layer (i.e. single-layer) LOMA MAP to which all RAN resources (e.g. radio resources, transmission powers) are associated. In the one-layer LOMA MAP, the geographical area of the RAN is divided into multiple zones, each of which is associated with pre-determined RAN parameters. In the one-layer LOMA MAP, the unit to quantify each RAN resource can be fixed. In other words, each RAN resource may be defined with an identical unit in different dimensions. Currently, a one-layer LOMA MAP is generated without the application of artificial intelligence (AI) techniques.

The present disclosure provides a method and apparatus for network resource management that uses location information for network resource management and control. According to embodiments, an AI-enabled multi-layer LOMA MAP, which is generated by a LOMA controller, realizes flexible resource sharing in a LOMA RAN. According to embodiments, MAP-based resource planning and scheduling can be enabled to jointly determine the pre-configured resource sets (e.g. Tx/Rx resource sets), MCS and downlink transmit power (TP) information for UEs and network infrastructures within a downlink LOMA MAP. A multi-layer zone configuration may be provided to decouple the resources and MCS mapping to specific locations for flexible resource sharing.

According to embodiments, a multi-type resource unit (RU) may be provided to simplify resource representation and RU scheduling and access procedure. The types and amounts of the dynamic RUs (i.e. RU types and amounts) may be determined by a RU management AI function based on a pre-determined RU scheduling and access algorithm, and the data traffic distribution. With the use of dynamic RUs, simpler RU scheduling and access algorithms can be applied in the LOMA RAN in order to achieve performance levels at least in line with those that may be achieved by more complex algorithms. This can accordingly simplify resource representation and RU scheduling and access procedure.

According to embodiments, there may be provided a LOMA controller that is configured to manage generation, updating and distribution of LOMA MAP(s). The LOMA controller may include a MAP management function, a data storage function and one or more AI functions (e.g. a zone division AI function, a RU management AI function). According to embodiments, the uplink and downlink data transmissions can be performed using the LOMA MAP while reducing the uplink and downlink control signal overheads for LOMA RAN. The configuration of a multi-layer LOMA MAP used for uplink and downlink data transmissions is illustrated elsewhere in the present disclosure.

According to embodiments, LOMA is provided to realize an AI assisted radio resource planning and simplified uplink/downlink data transmissions. AI assisted radio resource planning can leverage AI techniques in order to determine radio resource reuse and planning strategies for the future RANs. Specifically, AI assisted radio resource planning may include an AI-enabled multi-layer LOMA MAP to enable the dynamic sharing of radio resource(s) that can be pre-allocated to different locations or geographical areas in the RAN. The AI assisted radio resource planning may also enable a dynamic RU which quantifies the radio resource(s) pre-allocated to different locations or geographical areas in the RAN. The types and amounts of RUs that can be customized by the AI function (e.g. RU management AI function) based on one or more of the traffic distribution and performance feedbacks from the applied radio resource scheduling/access algorithms. Simplified uplink and downlink data transmissions may be realized due to the multi-layer LOMA MAP and dynamic RUs generated to resolve the complexity of uplink/downlink resource access and scheduling. Simplified uplink and downlink data transmissions can reduce the signaling overhead for uplink/downlink data transmission control.

### Multi-Layer LOMA MAP

According to embodiments, a LOMA MAP can be locally stored at each LOMA wireless entity. A LOMA MAP includes information (e.g. mapping or association rules) that defines mapping between the geographical location of a LOMA wireless entity and the pre-allocated RAN resources and pre-configured RAN parameters. In some embodiments, a LOMA MAP can be defined for each network slice or service. In some embodiments, multiple LOMA MAPs can be provided to a RAN. For example, a downlink LOMA MAP and an uplink LOMA MAP can be provided to one LOMA RAN in order for the LOMA RAN to conduct downlink and uplink data transmissions, respectively.

Using the LOMA MAP, the LOMA wireless entity can determine, either directly or indirectly, available network resources and suitable RAN configurations for uplink and downlink communications. A LOMA wireless entity may determine available network resources and suitable RAN configurations based on its location in the LOMA RAN. The LOMA MAP may include one or more LOMA parameters which may include pre-defined resource allocation information and RAN configurations (e.g., assigned MCS level, transmit power, etc.).

In some embodiments, a LOMA MAP may be a multi-layer LOMA MAP. In a multi-layer LOMA MAP, the geographical area of a LOMA RAN is divided, by a zone division AI function, into one or more zones with a size and a shape. The determination of the size and shape can be arbitrary or based on a predefined determination method. Each zone is a sub-area of the geographical area of the LOMA RAN, and is associated with one or more types of LOMA parameters.

A multi-layer LOMA MAP of the present disclosure includes hierarchical zones. For example, a multi-layer LOMA MAP may include upper-layer zones (i.e. zones in an upper-layer) and lower-layer zones (i.e. zones in a lower-layer). Each upper-layer zone may be associated with one or more lower-layer zones. The zones in different layers are associated with different subsets of the LOMA parameters, but the zones in the same layer are associated with the same subset of the LOMA parameters while containing different values. This configuration of a LOMA MAP is very different from a single layer LOMA MAP, where all zones are organized in the same layer without overlapping and are associated with identical type(s) of LOMA parameters,

In various embodiments, LOMA wireless entities located in the same layer zone can share the associated network resources and use the same associated RAN configurations (e.g. LOMA parameters). If LOMA wireless entities are, for example, located in different lower-layer zones and located in the same upper-layer zone, these LOMA wireless entities can share the resources associated with the upper-layer zone (e.g. radio resource set allocated to the upper-layer zone), and use the same RAN configurations (e.g. LOMA parameters, MCS level, TP level, beam ID) associated with the upper-layer zone. In various embodiments, a LOMA RAN operator determines the mapping between the LOMA parameters and the layers based on the service requirements and LOMA RAN status. The LOMA RAN operator can also determine the number of layers which are to be defined in a multi-layer LOMA MAP.

It should be noted that the present disclosure discloses a multi-layer LOMA MAP wherein the number of the layers in a multi-layer LOMA MAP is greater than one. Moreover, a multi-layer LOMA MAP of the present disclosure enables the flexible resources sharing associated with the same layer zones (e.g. same upper-layer zones), which results in higher resource utilization ratio for a LOMA RAN. The RAN configuration (e.g. LOMA parameters, RAN parameters) associated with an upper-layer zone can be directly copied to and used by LOMA wireless entities located in different lower-layer zones that are associated with the same upper-layer zone. As such, the representation of multi-layer LOMA MAP can be simplified and data consumption can be reduced, when compared to associated prior art.

According to embodiments, radio resource set assigned to a zone in a LOMA MAP can be quantified into one or more resource units (RUs). Each RU may be defined in three dimensions in terms including transmit power (TP) (e.g. TP of beam for downlink LOMA, TP of UE for uplink LOMA), bandwidth and time-interval. In various embodiments, a LOMA RAN operator determines the unit of each dimension of the RU based on computing cost and resource allocation accuracy requirements.

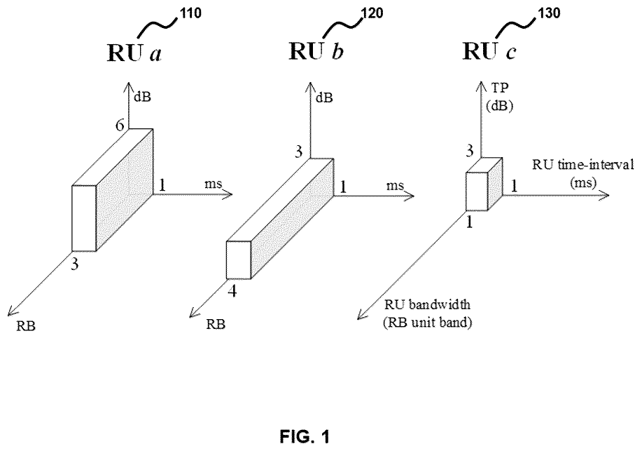

FIG. 1 illustrates example resource units (RUs) 110, 120 and 130 in a LOMA MAP, in accordance with embodiments of the present disclosure. The RUs 110, 120 and 130 are defined in three dimensions including TP, bandwidth and time-interval. The units for TP, bandwidth and time-interval are decibel (dB), resource block (RB, 180 kHz) and millisecond (ms), respectively.

The shape and volume of each of the RUs 110, 120 and 130 can be determined by the values of each RU's TP, bandwidth and time-interval. For example referring to FIG. 1, the RU 110 is associated with 6 dB of TP, occupies 3 RBs of bandwidth and 1 ms time interval. Therefore, the shape and volume of the RU 110 can be expressed as (6, 3, 1). Similarly, the RU 120 is associated with 3 dB of TP, occupies 4 RBs of bandwidth and 1 ms time interval, and the RU 130 is associated with 3 dB of TP, occupies 1 RB of bandwidth and 1 ms time interval. Therefore, the shapes and volumes of the RUs 120 and 130 can be expressed as (3, 4, 1) and (3, 1, 1), respectively.

According to embodiments, RUs with identical shape and volume can be categorized as the same RU type. In other words, the type of each RU (RU type) can be determined based on the shape and the volume of the RU. Therefore, the RUs 110, 120 and 130 in FIG. 1 are categorized in three different RU types, as the RU 110 has shape and volume defined as (6, 3, 1), the RU 120 has shape and volume defined as (3, 4, 1) and the RU 130 has shape and volume defined as (3, 1, 1).

According to embodiments, for each zone associated with a radio resource set in a LOMA MAP, the associated radio resource set can be quantified using multiple types of RUs with different RU amounts for each type.

In various embodiments, the RU management AI function can determine the RU types and the RU amount of each RU type (i.e. RU types and amounts) based on the zone division results (acquired from the zone division AI), data traffic distribution and feedback from RU scheduling and access algorithms. As the RU management AI function can dynamically adjust the RU types and amounts according to variations of data traffic distributions, the LOMA RAN can achieve higher resource utilization ratio (e.g. RU utilization ratio) and lower scheduling/RU access latency. Further, as the RU management AI function determines the RU types and amounts in consideration of feedback from the RU scheduling and access algorithms, the LOMA RAN can also achieve the same or substantially similar RU scheduling/access performance using simpler RU scheduling/access algorithms, in comparison with more complex RU scheduling/access algorithms that have been used in the prior art. Therefore, the computing cost and control signal overhead can be mitigated. The RU management AI function is further illustrated below or elsewhere in the present disclosure.

According to embodiments, the multi-layer LOMA MAP can be represented using a concept of a LOMA MAP tile (i.e. LOMA tile or Tile). A LOMA tile can be considered a minimal area unit associated with the geographic area covered by the LOMA RAN. Given that this minimal area unit (i.e. Tile) cannot be further divided spatially, a Tile may configured to be small enough to ensure no significant pathloss variations therein, but large enough to meet the accuracy requirement of the precise positioning technique(s) (e.g. GPS with an error range of about one meter).

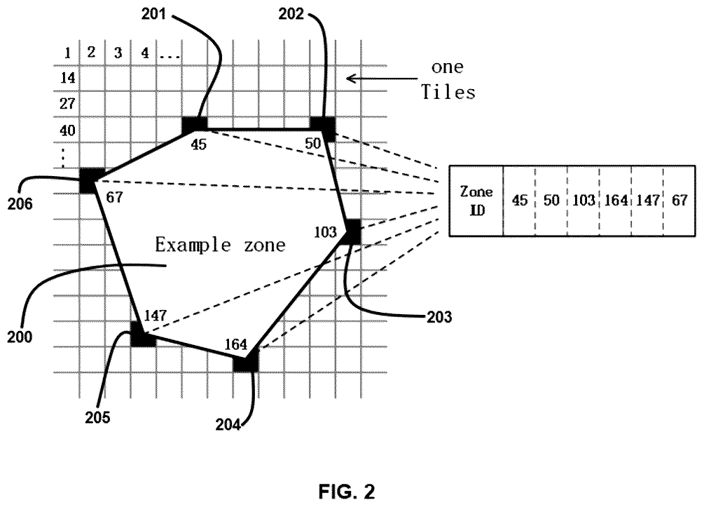

In a multi-layer LOMA MAP, the LOMA RAN is quantified into multiple Tiles with identical size and shape. The shape of the Tile must ensure tessellation or complete tiling of an area to be tiled, in order to prevent radio coverage blind points. In other words, the Tiles must cover the geographic area of the LOMA RAN without gaps or overlap. The Tiles in different multi-layer LOMA MAPs may have different sizes and shapes. Each Tile in the LOMA RAN can be assigned a unique ID, for example as illustrated in FIG. 2. The size and shape of the Tile and the sorting rule of the Tile ID may be determined by the LOMA RAN operator.

In some embodiments, to reduce the size (e.g. bit consumption) of the multi-layer LOMA MAP, only vertex Tiles are used to represent one zone of the multi-layer LOMA MAP. For example, as illustrated in FIG. 2, the zone 200 is defined as the polygon area surrounded by the lines connecting the six vertex Tiles 201, 202, 203, 204, 205 and 206. Each of the six vertex Tiles 201, 202, 203, 204, 205 and 206 has its own unique Tile ID (zone ID) 45, 50, 103, 164, 147 and 67, respectively. All Tiles within the polygon area which includes the Tiles traversed by the lines connecting the six vertex Tiles, are considered the zone 200. To enable this representation method, all Tiles in the LOMA RAN are enumerated and sorted by the LOMA RAN operator to generate a coordinate system. This information for representation of all Tiles in the LOMA RAN is broadcasted to LOMA wireless entities, for example when the LOMA wireless entities perform the actions related to the initial access to the LOMA RAN.

For a multi-layer LOMA MAP, a zoning scheme can be defined in terms of how the geographic area of the LOMA RAN is divided into one or more zones and how different zones are associated with various LOMA parameters. For example, a conventional LOMA MAP follows a one-layer zoning scheme, and a multi-layer LOMA MAP has zones in at least two layers and follows the two or more-layer zoning scheme.

In a multi-layer LOMA MAP, the size, shape and boundaries of a zone are constrained by the radio coverage area of the beam with which all LOMA wireless entities within the zone are associated. It is noted that a beam can be considered a wide beam (e.g. a circle area covered by an access point or infrastructure equipped with omnidirectional antenna, a 120-degree wide beam cell sector as defined in existing cellular system) where multi-user multiple-input and multiple-output (MU-MIMO) and beamforming techniques are not applied (e.g. general IoT, previous generations cellular system). In the case where MU-MIMO and beamforming techniques can be applied, a beam can be considered a sharp beam as can be associated with for example 5G New Radio (NR) and 6G wireless networks.

According to embodiments, each zone is fully covered by its associated beam and no geographic area of the zone can cross boundaries of radio coverage areas of two adjacent beams. The total radio resource set can be spatially reused within the beam. Within each beam, the total radio resource set is divided and each (for example divided) radio resource set can be allocated to one or more zones by the zone division AI function, based on one or more of network data traffic distributions and wireless channel states. In various embodiments, the zone division AI function supports generation of accurate multi-layer LOMA MAP(s) for a variety of complex scenarios. The zone division AI function is discussed in further detail below or elsewhere in the present disclosure.

In each multi-layer LOMA MAP, an effective interval can be defined as a period of time without significant variations for uplink/downlink traffic distribution and wireless channel state distribution in the LOMA RAN. A wireless channel state may indicate statistical pathloss (e.g. large-scale pathloss and shadowing) whose values are static (or with a very small range of variations) during an effective interval of the multi-layer LOMA MAP.

If either of traffic distribution or channel state distribution varies more than a predetermined range (e.g. exceeds a predefined threshold), the corresponding LOMA parameters would be no longer be valid, and therefore the (multi-layer) LOMA MAP should be re-generated to in order to adapt the new RAN environment. The effective interval of the LOMA MAP may be determined by the LOMA RAN operator (e.g. few hours) based on one or more of the statistical traffic and channel state distributions. The effective interval of the LOMA MAP may be dynamically stopped upon detection of significant variations for traffic distributions or channel state distribution. It is noted that in each (multi-layer) LOMA MAP, as the modulation and coding scheme (MCS) level associated with each zone is fixed, the fast fading effect of wireless channels may cause instantaneous vibrations of data transmission performance at certain moments during the effective interval. However, the statistical data transmission performance in each zone can still match the associated MCS level.

According to embodiments, for uplink/downlink data transmissions in a multi-layer LOMA MAP, the LOMA parameters include one or more of allocated radio resource information, MCS information, TP information and beam information.

The allocated radio resource information can define the radio resource set allocated to the LOMA wireless entities for uplink/downlink data transmissions. Each radio resource can be associated with one or multiple LOMA wireless entities within a certain geographic area. The information of basic units to quantify the allocated radio resource, and the amounts of radio resources can also be included in allocated radio resource information.

The MCS information can define the MCS used by one or more LOMA wireless entities for transmitting or receiving uplink/downlink data.

The transmission power (TP) information can define the TP used by one or more LOMA wireless entities for uplink/downlink data transmission.

The beam information can define the beam ID used by one or more LOMA wireless entities when performing uplink/downlink data transmission. The beam information may be an optional parameter for LOMA wireless entities in MU-MIMO RAN.

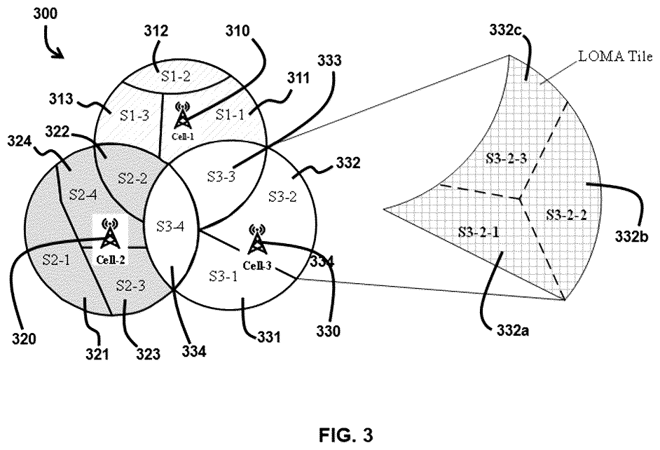

According to some embodiments, the downlink LOMA MAP(s) may be organized in a two-layer zoning scheme to enable more flexible radio resource sharing, as illustrated in FIG. 3. FIG. 3 illustrates an example two-layer downlink LOMA MAP 300 for a LOMA RAN with three infrastructures equipped with omnidirectional antennas (i.e. cell 310, cell 320 and cell 330), in accordance with embodiments of the present disclosure. In the two-layer downlink LOMA MAP 300, the upper-layer zone is referred to as the spectrum reuse region (SR-region) which is a contiguous area within the LOMA RAN. Specifically referring to FIG. 3, the LOMA RAN area covered by the cell 310 is divided into three SR-regions 311, 312 and 313; the LOMA RAN area covered by the cell 320 is divided into four SR-regions 321, 322, 323 and 324; and the LOMA RAN area covered by the cell 330 is divided into four SR-regions 331, 332, 333 and 334. The SR-region defines available radio resources and downlink TP for all LOMA wireless entities (e.g. UEs) therein. All LOMA wireless entities (e.g. UEs) within the same SR-region share one pre-configured resource set. According to embodiments, in the two-layer downlink LOMA MAP 300, the SR-regions associated with different beams (different SR-regions) may reuse the radio resource sets spatially. For example, the SR-regions 322 and 334 may reuse the same radio resource set which is provided by the cell 320 and the cell 330, respectively. In the two-layer downlink LOMA MAP 300, the TP level of the infrastructure (e.g. cell 310, cell 320 and cell 330) to all LOMA wireless entities (e.g. UEs) in the SR-region can be same

In the two-layer downlink LOMA MAP 300, each SR-region can be further divided into one or more lower-layer zones. In other words, each SR-region includes one or more lower-layer zones. A lower-layer zone is referred to as subzone or LOMA Zone. In FIG. 3, the SR-region 332 is divided into three subzones 332a, 332b and 332c. Each subzone is mapped to one MCS level. Each subzone in the two-layer downlink LOMA MAP 300 is defined by one or more LOMA tiles, as illustrated in FIG. 3.

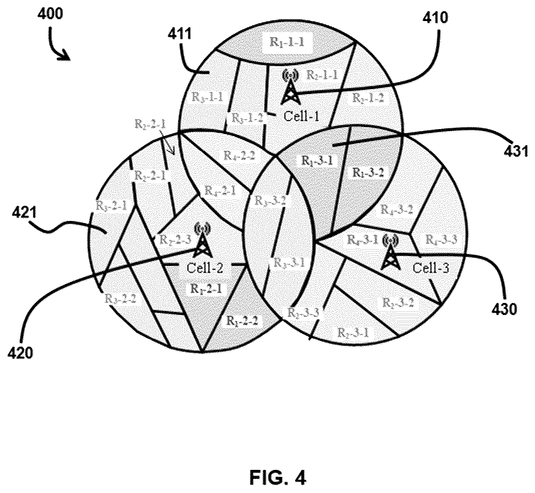

According to some embodiments, the uplink LOMA MAP(s) can be organized in either a two-layer zoning scheme, similar to the downlink LOMA MAP 300 of FIG. 3, or a one-layer zoning scheme as is illustrated in FIG. 4. FIG. 4 illustrates an example one-layer uplink LOMA MAP 400 for a LOMA RAN with three infrastructures equipped with omnidirectional antennas (i.e. cell 410, cell 420 and cell 430), in accordance with embodiments of the present disclosure.

For an uplink LOMA MAP organized in a two-layer zoning scheme, the upper-layer SR-region is associated with an available radio resource set. The lower-layer subzone is associated with a corresponding MCS level and TP range. The TP range can be the range that the LOMA wireless entities (e.g. UEs) in the subzone can adjust their TP in order to achieve the associated MCS level.

For an uplink LOMA MAP organized in a one-layer zoning scheme, as is illustrated in FIG. 4, there are one or more zones in the one-layer uplink LOMA MAP 400 where each zone is one contiguous area within the LOMA RAN (e.g. zone 411, zone 421, zone 431). All zones do not overlap each other and are associated with all LOMA parameters. It is noted that each zone may have different LOMA parameter values than other zones in the LOMA MAP 400. In a one-layer uplink LOMA MAP 400, LOMA wireless entities (e.g. UEs) within the same zone share the same set of pre-configured radio resources and the LOMA wireless entities in different zones may reuse these radio resource sets spatially. Each zone can be mapped to one MCS level. LOMA wireless entities in one zone can adjust their TP levels (within a given TP range) in order to achieve the associated MCS level.

It is noted that, for both the two-layer zone scheme and the one-layer zone scheme, the size, shape, MCS, TP range and spectrum reuse result can be determined by the zone division AI function with different solutions, respectively, which can be based on, for example, the statistical uplink/downlink traffic and signal to noise ratio (SNR) distribution in the LOMA access network. Each LOMA wireless entity (e.g. UE) can be only associated with one cell and the LOMA wireless entity association result may be jointly determined by the zone division AI function.

According to embodiments, a multi-layer LOMA MAP can be formatted to effectively organize and represent its contents including zone division and LOMA parameter association results.

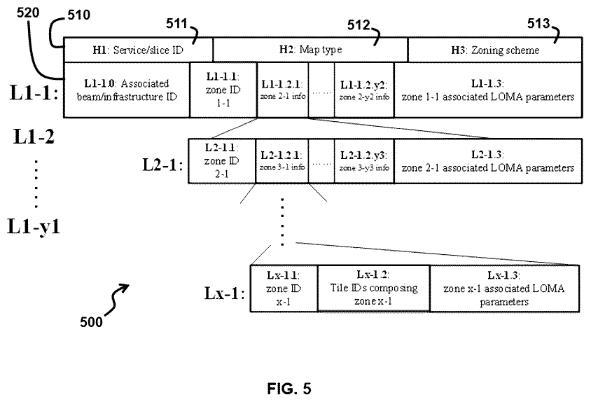

FIG. 5 illustrates an example format of a multi-layer LOMA MAP 500 in accordance with embodiments of the present disclosure. The header 510 of the multi-layer LOMA MAP 500 includes three segments. The three segments include segment 511 which includes information indicative of the associated network service/slice ID of the LOMA MAP, segment 512 which includes information indicative of the LOMA MAP type (e.g. downlink map for network infrastructure(s), uplink map for network infrastructure(s), downlink map for UE(s) and uplink map for UE(s)) and segment 513 which include information indicative of the zoning scheme of the LOMA MAP (i.e. number of zone layers).

In the header 510 of the multi-layer LOMA MAP 500, a unique ID is included. A unique ID is assigned to each zone, and may be in the format of X-Y, where X is indicative of the associated layer of the zone and Y is indicative of the unique number used to distinguish the zone from other zones in the same layer. The associated layer number X may range from the integer 1 to integer x, where 1 represents the highest layer and x represents the lowest layer. The value of x equals to the total number of zone layers defined in the segment 513. The unique zone number Y may range from 1 to yX, where yX is indicative of the total number of zones in layer X.

As illustrated in FIG. 5, after the header 510 of the multi-layer LOMA MAP 500, the zone information segments for all zones in the highest layer (e.g. layer number X=1) are sequentially enumerated in section 520. In section 520, each zone of the highest layer L1 is indicated as L1-1, L1-2, . . . , L1-y1, where y1 is the number of zones in the layer L1. More generally in FIG. 5, the zone information segment of zone X-Y (i.e. zone Y of the layer LX) is defined as LX-Y where X=1, 2, . . . , x (x is the total number of the layers) and Y=1, 2, . . . , yX (yX is the number of zones in the layer LX).

In various embodiments, each zone information segment LX-Y includes sub-segments LX-Y.1, LX-Y.2 and LX-Y.3 (Y=1, 2, . . . , yX where yX is the number of zones). The sub-segment LX-Y.1 includes information indicative of the unique ID for the zone (i.e. unique zone ID).

The sub-segment LX-Y.2 is the lower-layer zone information sub-segment. This sub-segment LX-Y.2 includes the zone information segments of all zones in the layer (i.e. layer L(X+1)) that is one layer lower than the layer LX. For example, zone information segments of L2-1 (e.g. zone 1 of the layer L2) can be stored in sub-segment L1-1.2.1. The length of sub-segment LX-Y.2 would be determined based on the number of the lower-layer zones included in the zone. For example referring to FIG. 5, sub-segment L1-1.2 includes multiple zone information segments of the lower-layer zones (i.e. L1-1.2.1, L1-1.2.2, . . . , L1-1.2.y2). In the case of the lowest layer zones (i.e. Lx), each of their lower-layer zone information sub-segments (i.e. Lx-Y.2 where Y=1, 2, . . . , yx) includes information indicative of the ID of Tiles that ae used in the lowest layer zone.

Sub-segment LX-Y.3 is the LOMA parameter information sub-segment. This sub-segment LX-Y.3 includes the information for LOMA parameters associated with the zone (e.g. associated MCS level, associated TP (for downlink LOMA MAP) or TP range (for uplink LOMA MAP), associated RU types and amounts). For zones associated with only some of the LOMA parameters, the sections for the LOMA parameters that are not associated can be omitted.

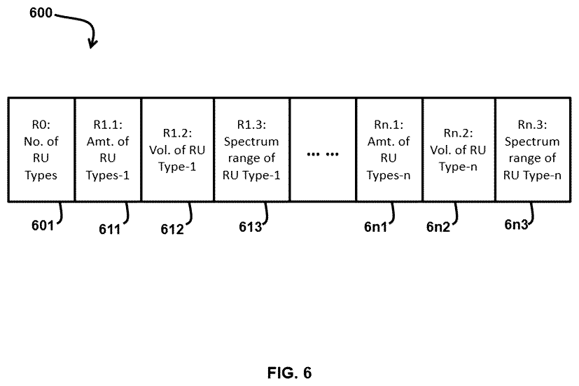

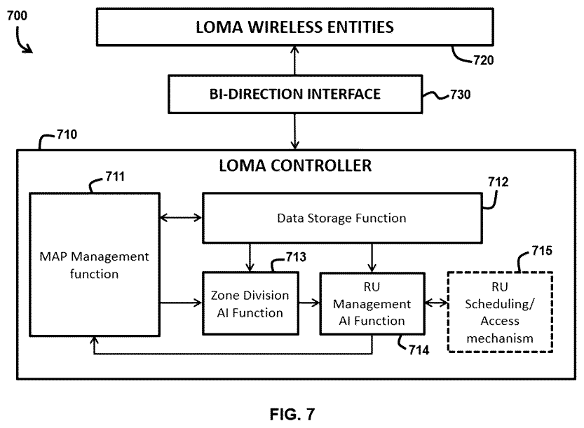

For a zone X-Y associated with a radio resource set, the LOMA parameter information sub-segment LX-Y.3 includes a RU information section. The RU information section includes information defining one or more of the total radio resource set information and the RU types and amounts (e.g., the RU information section 600 as illustrated in FIG. 6), which are optimized by the RU management AI function (e.g. RU management AI function 714 of FIG. 7).

It should be noted that in the case of the highest layer (i.e. L1), the zone information segment (i.e. L1-Y) further includes the sub-segment L1-Y.0 which includes information indicative of the beam ID or infrastructure ID (for an omnidirectional antenna) associated with the highest layer zone L1. This sub-segment L1-Y.0 is included only in the zone information segment of the highest layer zone L1.

According to embodiments, provided that the lower-layer zone information sub-segments for a higher layer zone are the zone information segments of all lower-layer zones under the higher layer zone, the multi-layer LOMA MAP format is organized in a hierarchical manner. Therefore, the multi-layer LOMA MAP may illustrate how each multi-layered zone in the LOMA MAP includes or is structured in a layer-by-layer way.

FIG. 6 illustrates an example RU information section 600 for a zone in a multi-layer LOMA MAP, in accordance with embodiments of the present disclosure. As illustrated in FIG. 6, the RU information section 600 provides the number of RU types (R0) used in the zone and the information for each RU type (RN). As illustrated in FIG. 6, the section for RN is structured to provide information sequentially for each RU type (N=1, 2, . . . , n where n equals the value of R0 (i.e. number of RU types used in the zone)).

Further referring to FIG. 6, subsection 601 includes information indicative of the number of RU types. The remaining portion of the RU information section 600 includes information for each RU type-N, where N=1, 2, . . . , n and n=number of RU types. For each RU type, information included in the the RU information section 600 includes the RU amount of the current RU type (e.g. subsections 611, 6n1), the shape and volume of one RU for the current RU type (e.g. subsections 612, 6n2) and the associated spectrum range of current RU type (e.g. subsections 613, 6n3). Put another way, the subsections 611 and 6n1 include information indicative of the amount of RU type-1 and RU type-n, respectively; the subsections 612 and 6n2 include information indicative of shape and volume of RU type-1 and RU type-n, respectively; and the subsections 613 and 6n3 include information indicative of the spectrum range of RU type-1 and RU type-n, respectively.

Regarding subsections 613 and 6n3 (i.e. spectrum range of the current RU type) of the the RU information section 600, provided that all of the same types of RUs sequentially occupy the associated spectrum range, each RU can be assigned with a unique ID indicating its location in the spectrum. For example, the unique ID may be in the form of ‘U-N-kN’ where N indicates the RU type and kN indicates the sequence number in the spectrum range. In this case, the max value of kN equals to the value of RN.1.

In some embodiments, the LOMA MAP(s) associated with (e.g. delivered to) LOMA wireless entities without mobility (e.g. network infrastructures) includes the zone information segments only for the zones within that LOMA wireless entity's radio coverage area, thereby reducing the amount of cache space needed for storage of the LOMA MAP(s).

In some embodiments, some LOMA wireless entities with mobility (e.g. mobile UEs) may use more than one LOMA MAP format. One LOMA MAP format delivers zone information segments of the zones in which the LOMA wireless entities with mobility (e.g. mobile UEs) are located. It should be noted that while minimizing the overhead of the initial LOMA MAP transmission to the LOMA wireless entities, this format requires massive LOMA MAP updates especially for the LOMA wireless entities with high mobility (e.g. UE frequently traversing different zones). Another LOMA MAP format defines the full LOMA MAP(s) of the LOMA RAN. While minimizing massive signal overheads for LOMA MAP(s) updates when LOMA wireless entities (e.g. UEs) move around across multiple zones, this format results in high overhead of initial LOMA MAP transmission to the LOMA wireless entities.

### LOMA Controller

According to embodiments, the LOMA controller in the LOMA RAN provides one or more functions to generate, update and distribute the multi-layer LOMA MAP(s) (e.g. deliver the multi-layer LOMA MAP(s) to the LOMA wireless entities). In some embodiments, the LOMA controller may be a logical entity (e.g. logical controller). In some embodiments, the LOMA controller may be implemented on one or multiple physical network entities (e.g. servers, clouds) in a centralized or distributed manner. The LOMA controller may include a MAP management function, a data storage function and one or more AI functions. The MAP management function controls the generation and delivery (e.g. distribution) of multi-layer LOMA MAP(s). The data storage function stores and processes uploaded traffic and signal-to-noise ratio (SNR) data, which can be used for generation of the multi-layer LOMA MAP. The traffic and SNR data may be acquired (e.g. uploaded) from the LOMA wireless entities. The AI function implements necessary AI models to generate the multi-layer LOMA MAP(s). In some embodiments, the LOMA controller may include multiple AI functions, as required for provision of services (e.g. zone division AI function and RU management AI function).

The LOMA controller enables the necessary functions to generate multi-layer LOMA MAP(s). The generated multi-layer LOMA MAP(s) can be applied to various networks including those with complex scenarios which cannot be addressed by the conventional model-based maps. For example, in a RAN where infrastructure and blockage buildings are unevenly distributed, it can be impossible or at least challenging to calculate the pathloss distribution using traditional wireless channel models. However, the LOMA controller can be configured to use AI functions associated therewith which can be used for calculating the pathloss distribution, with sufficient accuracy, based on one or more of the channel condition and the SNR data acquired from the LOMA wireless entities (e.g. UEs and infrastructures).

FIG. 7 illustrates an example LOMA controller architecture in accordance with embodiments of the present disclosure. Referring to FIG. 7, there is provided a LOMA RAN 700 including the LOMA controller 710 and the LOMA wireless entities 720. The LOMA controller 710 and the LOMA wireless entities 720 are communicatively connected to each other via the bi-direction interface 730.

The LOMA controller 710 is a logical controller which can be implemented in either a centralized or distributed manner in substrate networks. The LOMA controller 710 includes the MAP management function 711, data storage function 712, Zone division AI function 713 and RU management AI function 714. The LOMA controller 710 may further include a unit containing one or more RU scheduling/access algorithms (i.e. RU scheduling/access unit 715). The MAP management function 711 monitors network variations in order to determine if and when to initiate LOMA MAP generation or LOMA MAP update process. The MAP management function 711 also updates and distributes (e.g. broadcasts, transmits) the LOMA MAP(s) to various LOMA wireless entities in the LOMA RAN. The data storage function 712 receives traffic and SNR data from LOMA wireless entities, generates the training data by processing the received traffic and SNR data, and provides the processed training data to the AI functions. The Zone division AI function 713 is configured to provide different AI solutions to different schemes (e.g one-layer scheme, two-layer scheme). The RU management AI function 714 is configured to provide different AI solutions (e.g., reinforcement learning based solution) for all schemes (e.g. with different inputs).

The bi-direction interface 730 is defined for communication between the LOMA controller 710 and LOMA wireless entities 720. The bi-direction interface 730 is needed as data is transmitted in two directions. The data is transmitted from the LOMA controller 710 to LOMA wireless entities 720 when the LOMA wireless entities 720 upload, to the data storage function 712 of the LOMA controller 710, locally collected raw traffic (e.g. uplink and/or downlink traffic) and SNR data. The data is transmitted from LOMA wireless entities 720 to the LOMA controller 710 when the LOMA wireless entities 720 download, from the LOMA controller 710, the LOMA MAP(s) generated or updated by the LOMA controller 710.

According to embodiments, the LOMA controller 710 generates uplink/downlink LOMA MAP(s) for services/slices using one or more of its functions (i.e. MAP management function 711, data storage function 712, Zone division AI function 713 and RU management AI function 714). The process for generating a LOMA MAP and related activities performed by the functions of the LOMA controller 710 are further defined below with reference to FIG. 7.

The MAP management function 711 monitors for variations of data stored in data storage function 712. Provided that the raw traffic and SNR data are received from LOMA wireless entities via the bi-direction interface 730, the data storage function 712 processes (e.g. calculates, analyzes) the received traffic and SNR data to generate the LOMA MAP(s). The data storage function 712 stores the processed data which includes uplink/downlink channel state distribution data, uplink/downlink spatial traffic distribution data and uplink/downlink temporal traffic distribution data.

The uplink/downlink channel state distribution dataset, hereinafter referred to as D1, includes the uplink and downlink channel state indicator (e.g. pathloss value) of each Tile to the associated available infrastructures. The associated available infrastructure are all infrastructures that can effectively transmit downlink data to or receive uplink data from the UEs in the Tile. Each channel state indicator stored in this dataset includes a statistical result, which can be calculated based on the SNR data uploaded from the LOMA wireless entities in the Tile.

The uplink/downlink spatial traffic distribution dataset, hereinafter referred to as D2, stores the spatial distribution of the uplink/downlink data traffic over the RAN areas. The spatial distribution may be represented in unit of Tile. Each data traffic value stored in this dataset includes a statistical result, which can be calculated based on the raw traffic data received from LOMA wireless entities in the Tile.

The uplink/downlink temporal traffic distribution dataset, hereinafter referred to as D3, stores the temporal distribution of the uplink/downlink data traffic for each LOMA wireless entity in LOMA RAN.

In some embodiments, the data storage function 712 supports de-privacy mechanisms in order to prevent privacy data leaking to third-party providers of AI model.

According to embodiments, the LOMA MAP may be generated when significant environment variations are observed. In other words, when the MAP management function 711 observes that variations of any data distributions in D1, D2 and D3 exceed the predetermined thresholds, the MAP management function 711 triggers the LOMA MAP generation process. Otherwise, the MAP management function 711 keeps monitoring data stored in data storage function 712 and sees if there is any significant environment variation.

When significant environment variation is observed, the MAP management function 711 may send a LOMA MAP generation request to the zone division AI function 713. The LOMA MAP generation request may include one or more of: types of LOMA MAP to be generated (e.g. uplink LOMA MAP or downlink LOMA MAP), zoning scheme (e.g. one-layer zoning scheme or two-layer zoning scheme) and service/slice specific requirements for generation of the LOMA MAP (e.g. granularity of zones, predetermined LOMA parameter ranges).

Upon receiving the LOMA MAP generation request, the zone division AI function 713 requests training data from the data storage function 712 in order to calculate the zone division result. The training data acquired from the data storage function 712 includes D1 (i.e. uplink/downlink channel state distribution data) and D2 (i.e. uplink/downlink spatial traffic distribution data).

In various embodiments, AI techniques and processes realized in the zone division AI function 713 may be customized by the LOMA RAN operator or third-party AI solution providers in consideration of the input and output contents (e.g. training data D1, D2, zone division results).

In some embodiments, the zone division AI function 713 jointly determines the size and shape of the zones of the LOMA RAN as well as the associated LOMA parameters for each zone of the LOMA MAP organized in one-layer zoning scheme.

In some embodiments, the zone division AI function 713 determines the size and shape of the LOMA RAN and the associated LOMA parameters for zones in different layers. The zone division AI function 713 may determine hierarchically from the highest layer to the lowest layer in a step-by-step manner. For example, a two-layer downlink LOMA MAP may be generated by the zone division AI function 713 as follows.

Given the training data D1 and D2, a clustering algorithm based AI is applied for the upper-layer zone division in order to divide the LOMA RAN into one or more upper-layer zones. The clustering algorithm based AI may be applied for each beam, and the clustering parameters (e.g. total number of upper-layer zones within the beam) may be customized by the LOMA RAN operator.

Given the upper-layer zone division result (e.g. the size and shape of the LOMA RAN and the associated LOMA parameters for the upper-layer zones) and the related training data D1 and D2, a resource allocation and LOMA parameter configuration algorithm may be applied to allocate radio resource sets and to configure LOMA parameters for different upper-layer zones. The resource allocation and LOMA parameter configuration algorithm can be applied over the whole LOMA RAN to realize spatial reuse between the upper-layer zones in different beams and to minimize the interference between the upper-layer zones. In some embodiments, the resource allocation and LOMA parameter configuration may be a combination of two separate algorithms which are a resource allocation algorithm and a LOMA parameter configuration algorithm.

Given the upper-layer zone division result (e.g. the size and shape of the LOMA RAN and the associated LOMA parameters for the upper-layer zones) and the related training data subsets of D1 and D2 for each upper-layer zone, a clustering algorithm based AI, which may be different from the one used for upper-layer zone division, is applied to further divide the upper-layer zone into one or more lower-layer zones (Subzones or LOMA Zones). The lower-layer zone division is processed in the similar manner as the process for the upper-layer zone division.

Given the lower-layer zone division result (e.g. the size and shape of the LOMA RAN and the associated LOMA parameters for the lower-layer zones) and the related training data subsets of D1 and D2 for each upper-layer zone, a resource allocation and LOMA parameter configuration algorithm, which may be different from the one used for upper-layer resource/LOMA parameter configuration, is applied to allocate radio resource sets and to configure LOMA parameters for different lower-layer zones. The resource allocation and LOMA parameter configuration algorithm is applied over all lower-layer zones within the upper-layer zone in order to attempt to minimize the interference between these zones. In some embodiments, the resource allocation and LOMA parameter configuration may be a combination of two separate algorithms which are a resource allocation algorithm and a LOMA parameter configuration algorithm.

When the zone division process is complete, the zone division AI function 713 outputs the zone division result to the RU management AI function 714 for determining RU types and amounts. The zone division result includes one or more of size and shape of each zone of any layers (e.g. upper and lower layers), the associated radio resource set(s) and the LOMA parameters for each zone of any layers (e.g. upper and lower layers).

In order to determine RU types and amounts, the RU management AI function 714 acquires D3 (i.e. uplink/downlink temporal traffic distribution data) from the data storage function 712. The RU management AI function 714 combines D3 obtained from the data storage function 712 and the zone division result received from the zone division AI function 713, and then determines RU types and amounts based on the combined information.

In some embodiments, the RU management AI function 714 is designed based on reinforcement learning (RL) technique. This allows for iterative adjustment of the RU types and amounts for each zone associated with radio resource set, based on the feedback of the predetermined RU scheduling (for downlink) or RU access (for uplink) algorithms. It is noted that the RU management AI function 714 is executed only for each zone associated with radio resource set.

For each zone associated with the radio resource set, the RU management AI function 714 in each step/iteration of the training process can generate an intermediate decision of the RU types and amounts including the radio resource set. This intermediate decision may be applied by the RU scheduling/access unit 715 to schedule the same training traffic data (e.g. total training data set or a subset thereof) used in the corresponding step. The RU scheduling/access unit 715 may contain a predetermined RU scheduling/access algorithm. Upon application of the intermediate decision, the RU scheduling/access unit 715 may provide feedback for the performance of the RU scheduling/access to the RU management AI function 714. The feedback may be provided in the form of a performance matrix which includes information indicative of average scheduling/RU access latency, average throughput, RU access collision ratio, RU utilization ratio, etc.

Upon receiving the RU scheduling/access performance feedback, which may be in the form of a performance matrix, from the RU scheduling/access unit 715 (e.g. predetermined RU scheduling/access algorithm), the RU management AI function 714 calculates weighted mean scores for all elements in the performance matrix as performance rewards. The higher performance reward indicates better performance on data (e.g. low scheduling/RU access latency, high throughput, low RU access collision ratio, and high RU utilization ratio). The calculated performance reward may be conveyed back (e.g. back-propagated) to the neural networks (NN) in the RU management AI function 714 for (further) adjustment of the LOMA parameters.

As the NN in the RU management AI function 714 can learn any temporal distribution features of the raw traffic data, the decision for the RU types and amounts can converge to the optimal decision, which achieves highest performance reward, after a number of iterations. This optimal decision obtained after a number of iterations would be the final decision for the RU types and amounts that is suitable for the data traffic in the corresponding zone and also suitable for the predetermined RU scheduling/access algorithm included in the RU scheduling/access unit 715.

It is noted that any algorithms provided by the LOMA RAN operator or third party solutions can be the predetermined RU scheduling/access algorithm. Unlike the RU scheduling/access algorithm implemented on the LOMA wireless entities for real data transmissions, the RU scheduling/access algorithm included in the RU scheduling/access unit 715 is implemented by the LOMA controller (in the AI function) to conduct virtual scheduling/access control for the purpose of training and testing data of the RU management AI function 714.

Upon generating the RU types and amounts decision for each zone associated with radio resource set, the RU management AI function 714 combines the RU types and amounts decision with the zone division result received from the zone division AI function 713 in order to generate the LOMA MAP. Then, the RU management AI function 714 generates the LOMA MAP using said combined information.

Upon generation of the LOMA MAP, the MAP management AI function 711 receives the generated LOMA MAP(s) from the RU management AI function 714. Then, the MAP management AI function 711 customizes the format of the LOMA MAP(s) and transmits the LOMA MAP(s) to the LOMA wireless entities 720.

Data Upload from LOMA Wireless Entity

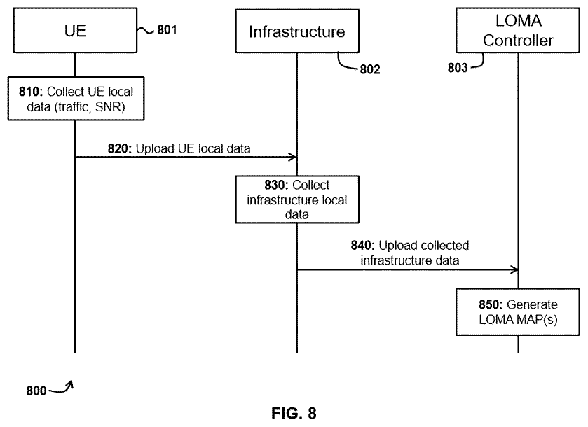

As illustrated above and elsewhere in the present disclosure, various LOMA controller functions (e.g. MAP management function 711, data storage function 712, Zone division AI function 713 and RU management AI function 714 of FIG. 7) communicate each other for generation of the LOMA MAP. According to embodiments, the LOMA MAP generation process also requires the raw traffic and SNR data to be locally collected by LOMA wireless entities and to be uploaded to the LOMA controller (e.g. LOMA controller 710 of FIG. 7) via the bi-direction interface (e.g. bi-direction interface 730 of FIG. 7). FIG. 8 illustrates a procedure 800 for uploading data locally collected by LOMA wireless entities 801 and 802 to the LOMA controller 803, in accordance with embodiments of the present disclosure.

Referring to FIG. 8, the UE 801, at step 810, collects information locally, for example, traffic and SNR data, for LOMA MAP generation. In the case of the downlink LOMA MAP generation, the UE 801 collects a downlink SNR data tuple when the UE 801 moves to a new location which may be represented by Tile ID. The downlink SNR data tuple includes one or more of the timestamp for data tuple collection time, downlink SNR and location coordinate. The timestamp for data tuple collection time may be used by the LOMA controller 803 to match corresponding downlink traffic data collected at the same location and the data uploaded to the infrastructure 802, thereby achieving the traffic and channel state distributions. The downlink SNR may be collected from all available infrastructures. The location coordinate may be represented by Tile ID.

In the case of the uplink LOMA MAP generation, the UE 801 may generate uplink data when the UE 801 generates a new uplink message. The uplink data tuple includes one or more of the timestamp of message transmission, message size, service/slice ID, TP level to transmit the message and location coordinate. The timestamp of the message transmission may be used by the LOMA controller 803 to match corresponding uplink SNR data collected at the same location and the data uploaded to the associated infrastructure 802, thereby achieving the traffic and channel state distributions. The message size may be represented in unit bits and used to calculate the uplink traffic distributions. The message size does not include any other information related to the detailed message content. The TP level to transmit the message may be used to calculate the uplink traffic distributions. The location coordinate may be used to calculate traffic distribution and can be represented by Tile ID.

The UE 801, at step 820, uploads the UE local data to the infrastructure 802. In the case of the downlink LOMA MAP generation, the UE 801 may transmit, e.g., upload, the collected data tuples to its associated infrastructure 802 via uplink broadcast channel. It should be noted that the uplink broadcast channel may be detected by other infrastructures to facilitate their data collections. As both of the zone division AI function and RU management AI function do not require real-time traffic and SNR data updates, the collected data tuples can be uploaded at a predetermined frequency. The collected data tuples may be uploaded less frequently than the data tuple collection. In some embodiments, the UE 801 may upload the collected data tuples at contention-based non-periodical timings. The UE 801, in each upload, uploads all collected data tuples for the locations that the UE 801 has traversed since its last upload.

In the case of the uplink LOMA MAP generation, the UE 801 may upload the uplink data tuple with the new uplink message as an attachment (e.g. attached segment) or separately.

The infrastructure 802, at step 830, collects the local data, for example, when the local data has been uploaded. In the case of the downlink LOMA MAP generation, the infrastructure 802 locally monitors the downlink traffic and collects downlink traffic data tuple for each downlink message. The downlink traffic data tuple includes the timestamp, message size and service/slice ID. The timestamp indicates the data tuple collection time. The timestamp may be used by the LOMA controller 803 to match corresponding downlink SNR data collected at the same location and the data uploaded by the associated UE 801, thereby achieving the traffic and channel state distributions. The message size may be represented in unit bits and used to calculate the downlink traffic distributions. The message size does not include any other information related to the detailed message content.

In the case of the uplink LOMA MAP generation, the infrastructure 802 measures the uplink SNR for the received message based on the TP level provided in the uplink data tuple. The infrastructure 802 then attaches the uplink SNR data into the uplink data tuple received from the UE 801.

Upon completing the local data collection, the infrastructure 802, at step 840, uploads the collected data to the LOMA controller 803. In the case of the downlink LOMA MAP generation, the infrastructure 802 forwards the local data received from the UE 801 to the LOMA controller 803 as soon as the infrastructure 802 receives from the UE 801. While forwarding, the infrastructure 802 may also periodically upload the collected downlink traffic data tuples to the LOMA controller 803.

In the case of the uplink LOMA MAP generation, the infrastructure 802 forwards the uplink message with the processed uplink data tuple to LOMA controller 803. The uplink SNR data collected by the infrastructure 802 may be attached to the unlink message.

Upon receiving the data from the infrastructure 802, the LOMA controller 803, at step 850, generates the LOMA MAP(s). Given the uploaded data tuples, the LOMA controller 803 processes the uploaded data to generate the set of uplink/downlink spatial traffic distribution data, the set of uplink/downlink channel state distribution data, and the set of uplink/downlink temporal traffic distribution data. The generated dataset is stored at the LOMA controller 803. Using the stored datasets, the LOMA controller 803 generates the LOMA MAP(s) in accordance with the procedures illustrated above.

The LOMA MAP(s) generated by the LOMA controller 803 will be conveyed to the LOMA wireless entities (e.g. UE 801, infrastructure 802). The generated LOMA MAP(s) may be kept monitored and the accuracy of the LOMA MAP(s) can be improved with more traffic and SNR data being collected and uploaded.

### Delivery and Update of LOMA MAP

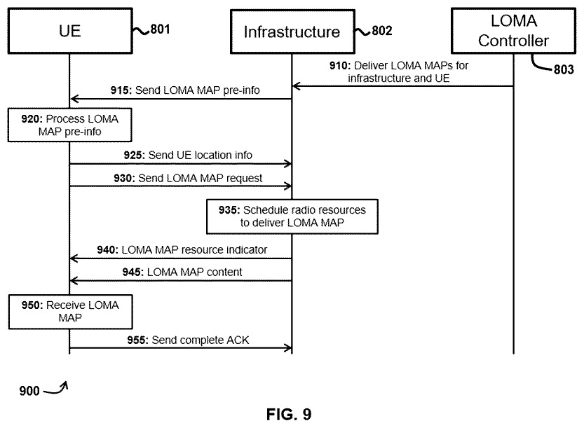

FIG. 9 illustrates a procedure 900 for initial delivery of LOMA MAP(s) to a new UE which accesses the LOMA RAN for the first time, in accordance with embodiments of the present disclosure. Referring to FIG. 9, the LOMA controller 803, at step 910, delivers the generated LOMA MAPs for both infrastructure and UE to the connected infrastructures 802 via bi-direction interface (e.g. bi-direction interface 730 of FIG. 7) between the LOMA controller 803 and the infrastructures 802. Each infrastructure 802 locally stores the LOMA MAPs for UE and infrastructure. The LOMA RAN related knowledge and information, such as size, shape and sorting rule of Tiles in the LOMA RAN, can be also delivered to the infrastructures 802 together with the LOMA MAPs. In addition, pre-configured data that is locally generated by the LOMA RAN operator may be also delivered to the infrastructures 802.

Each infrastructure 802 in the LOMA RAN, at step 915, transmits the LOMA MAP pre-information to the UE 801. The LOMA MAP pre-information may be broadcasted via the broadcast channel or directly conveyed to the UE 801. The LOMA MAP pre-information provides, to a new UE that initially accesses the LOMA RAN, various information needed to create the complete LOMA MAP. The LOMA MAP pre-information includes the geographical coordinate of the origin Tile in the LOMA RAN, the shape of Tiles, the size of Tiles, the size and shape of the LOMA RAN, and the Tile sorting rules. The geographical coordinate of the origin Tile may include information indicative of the latitude and longitude of the origin Tile's geometric center. The Tile shape includes information indicative of the shape of Tiles. The shape of Tiles may be pre-defined for example with integers (e.g. 0 for square, 1 for hexagon, etc.). The size of Tiles includes all information required to determine the size of Tiles completely (e.g. edge-length for the square Tile). The size and shape of the LOMA RAN include information regarding the geographical area of the LOMA RAN that is covered with Tiles. The geographical area may be a polygon that covers all LOMA wireless entities (e.g. UE 801, infrastructure 802) within the LOMA RAN. The shape of the polygon may be predetermined by the LOMA RAN operator. The size of the polygon may be expressed in unit of Tile (e.g. in terms of the number of Tiles). The Tile sorting rules include information indicative of how the Tiles are arranged and laid out (e.g. enumerated) in the LOMA RAN. It is noted that the LOMA RAN is composed of the Tiles. A unique integer number is assigned to each Tile based on the Tile sorting rule. The assigned integer is used as an ID of the Tile.

When the UE 801 accesses the LOMA RAN for the first time, it monitors the broadcast channel to receive the LOMA MAP pre-information so that it can receive the LOMA MAP pre-information when the infrastructure 802 broadcasts this pre-information. In some embodiments, the infrastructure 802 may send the LOMA MAP pre-information directly to the UE 801. Upon receiving the LOMA MAP pre-information and obtaining its GPS positioning results, the UE 801, at step 920, processes the LOMA MAP pre-information and obtains its geographic location. The geographic location of the UE 801 may be represented using the unique ID of the Tile in which the UE 801 is located. The UE 801 also obtains the basic coordinate system to represent the LOMA MAPs.

The UE 801 transmits, at step 925, its location information and, at step 930, the LOMA MAP request to the associated infrastructure 802. While the transmission of the location of the UE 801 and the LOMA MAP request are illustrated separately, the location of the UE 801 and the LOMA MAP request may be transmitted to the infrastructure 802 together or separately. As stated above, the location of the UE 801 is represented by the ID of the Tiles in which the UE 801 is located. The LOMA MAP request is a request for delivery of the initial LOMA MAP.

Upon receiving the LOMA MAP request from the new UE 801, the infrastructure 802, at step 935, schedules appropriate radio resources to deliver the LOMA MAP. The infrastructure 802, at step 940, sends the UE 801 an indicator message (i.e. LOMA MAP resource indicator) to inform the UE 801 of the radio resources scheduled for delivery of the LOMA MAP. Then, the infrastructure 802, at step 945, sends the LOMA MAP contents using the scheduled radio resources.

Upon receiving the indicator message (i.e. LOMA MAP resource indicator), the new UE 801, at step 950, monitors the radio resources indicated in the message in order to receive the LOMA MAP from the infrastructure 802. Once the LOMA MAP is received by the UE 801, the UE 801, at step 955, sends an acknowledgement (ACK) signal to the infrastructure 802 thereby confirming the successful reception of the LOMA MAP. The infrastructure 802 may keep transmitting the LOMA MAP content to the UE 810 until it receives the complete ACK signal from the UE 801.

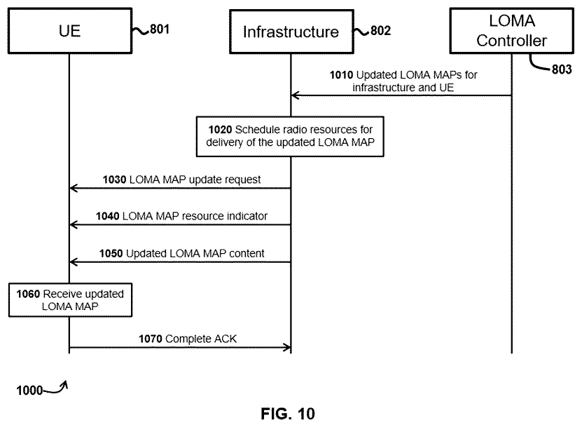

FIG. 10 illustrates a procedure 1000 for updating the LOMA MAP triggered by the LOMA controller, in accordance with embodiments of the present disclosure. Referring to FIG. 10, the LOMA controller 803, at step 1010, delivers the updated LOMA MAPs for both infrastructure and UE to the connected infrastructures 802 via bi-direction interface (e.g. bi-direction interface 730 of FIG. 7) between the LOMA controller 803 and the infrastructures 802. Each infrastructure 802 locally stores the LOMA MAPs for UE and infrastructure.

Upon receiving the updated LOMA MAP(s) from the LOMA controller 803, the infrastructure 802, at step 1020, schedules appropriate radio resources for delivery of the updated LOMA MAP for UE.

The infrastructure 802, at step 1030, broadcasts or directly transmits the LOMA MAP update request requesting for update the LOMA MAP to all associated UEs 801.

The infrastructure 802, at step 1040, sends an indicator (i.e. LOMA MAP resource indicator message) to inform the UE 801 of the radio resources scheduled for delivery of the LOMA MAP. The LOMA MAP resource indicator may include information indicative of whether the updated LOMA MAP contents can be broadcasted or directly transmitted to the UE 801. The LOMA MAP resource indicator may further include detailed information related to the broadcast or direct transmission of the updated LOMA MAP contents. The infrastructure 802, at step 1050, broadcasts or directly sends the LOMA MAP or the updated LOMA MAP or the updated LOMA MAP contents to the UE 801 using the scheduled radio resources.

At step 1060, one or more UEs 801 associated with the infrastructure 802 monitor the radio resources indicated in the LOMA MAP resource indicator in order to receive the updated LOMA MAP or the updated LOMA MAP contents. For each UE 801, once the updated LOMA MAP or updated LOMA MAP contents is received, the UE 801, at step 1070, sends an acknowledgement (ACK) signal to the infrastructure 802 thereby confirming the successful reception of the updated LOMA MAP. The infrastructure 802 may keep transmitting the updated LOMA MAP content to the UE 801 until it receives the complete ACK signal from all of the associated UEs 801.

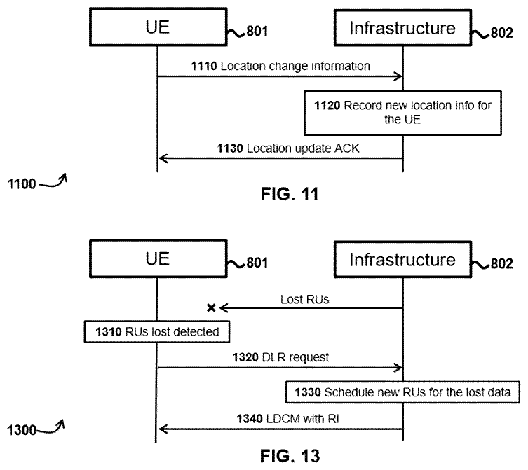

According to embodiments, each UE updates its location changing information to the LOMA network whenever it crosses the boundaries of two zones. The purpose of the location update is to ensure the LOMA infrastructures always have the correct information regarding the zone associated with the UEs and to determine appropriate MCS, TP and available RUs. FIG. 11 illustrates a procedure 1100 for updating the location of the UE to the associated infrastructure, in accordance with embodiments of the present disclosure.

Referring to FIG. 11, when the UE 801 crosses boundaries of zones, the UE 801, at step 1110, sends location change information to the infrastructure 802. The location change information may include one or more of ID of the UE 801 and new zone ID of the UE 801. The new zone ID may be recognized by the UE 801 using the stored LOMA MAP and GPS positioning results.

Upon receiving the location change information from the UE 801, the infrastructure 802, at step 1120, records new location information, for example based on the location change information which may include the new zone ID, for the UE 801, and calculates the corresponding LOMA parameters for uplink/downlink communications with the UE 801.

Once the new location information for the UE 801 is recorded, the infrastructure 802, at step 1130, sends an acknowledgement (ACK) signal to the UE 801, thereby confirming that there was change of the zone in which the UE 801 is located. This ACK signal (i.e. location update ACK signal) needs to be transmitted with the LOMA parameters of the UE 801's new zone.

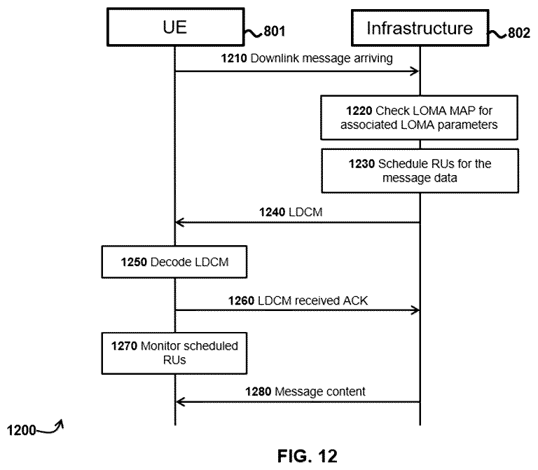

Provided that MCS level, UE uplink transmission TP and available RUs can be predetermined in LOMA MAP(s), the procedures for downlink resource scheduling and data transmission can be improved to exploit more signaling overhead saving. FIG. 12 illustrates a procedure 1200 for the LOMA MAP enabled downlink data transmission, in accordance with embodiments of the present disclosure.

Referring to FIG. 12, upon arrival of one downlink message at the infrastructure 802, the infrastructure 802, at step 1210, obtains the ID of the UE 801 for example from the downlink message.

At step 1220, the infrastructure 802 checks the current zone of the UE 801 in the downlink LOMA MAP(s) to determine LOMA parameters required for transmission of the downlink message. The required LOMA parameters include available RU set, MCS level and TP level.

At step 1230, the infrastructure 802 schedules RUs that are selected from the available RU set, according to a RU scheduling algorithm. As stated above, the RU management AI function (e.g. RU management AI function 714 of FIG. 7) determines the optimal RU types and amounts based on the scheduling algorithm design. Given the same performance requirements, the scheduling algorithm for downlink LOMA MAP(s) can be simplified by virtue of the RU management AI function. In some embodiments, for example, a non-weight based downlink scheduling algorithm may be applied. In the non-weight based downlink scheduling algorithm, message packets are equally treated in terms of priority. As such, the message packets are processed under the first-come-first-served rule. Unlike the traditional proportional fairness (PF) based algorithms, there is no need for weight calculations and weight based resource scheduling for the non-weight based downlink scheduling algorithm. Moreover, in the non-weight based downlink scheduling algorithm, different RUs may be scheduled in an avaricious manner according to the packet size and types of available RUs.

At step 1240, the infrastructure 802 sends a LOMA downlink control message (LDCM) to the target UE 801 in order to indicate the scheduled RUs via a downlink control channel (e.g. PDCCH). The LDCM may include IDs of the scheduled RUs. The MCS for the LDCM may be related to some modulation order such as quadrature phase shift keying (QPSK). The MCS for the LDCM may be associated with the Zone in which the target UE is located. The LDCM may contain one or more of the ID of the target UE 801, IDs of the scheduled RU and retransmission indicator (RI). The ID of the target UE 801 may be used to distinguish the target UE 801's LDCM from other UE's LDCM. The IDs of the scheduled RU may be a sequence of the scheduled RU IDs. The RI may be an integer indicative of the type of data transmission. For example, ‘0’ may indicate that the downlink data is newly arrived (i.e. new data transmission) and ‘1’ may indicate that the downlink data is retransmitted (i.e. data re-transmission) upon request of the target UE 801.

The UE 801 periodically monitors the downlink control channel in order to detect potential LDCM signal. When the UE 801 detects a LDCM signal containing its UE ID, the UE 801, at step 1250, decodes the LDCM to obtain scheduled RU IDs. Then, the UE 801 checks the stored downlink LOMA MAP based on its current geographic location, and determines the precise locations of scheduled RUs in the spectrum range and the associated MCS level for data receiving.

Once the LDCM is successfully decoded the UE 801, at step 1260, sends to the infrastructure 802 an acknowledgement signal confirming receipt of the LDCM signal (i.e. a LDCM received ACK). Then, at step 1270, the UE 801 monitors the scheduled RUs and waits for the downlink message content. Upon receiving the LDCM received ACK, the infrastructure 802 transmits the downlink message content (e.g. message data) to the UE 801 through the scheduled RUs.

According to embodiments, the LDCM achieves overhead savings when compared to a conventional downlink control message used in existing RAN. The overhead savings can be observed at least in the following aspects. First, all MCS indicator overheads are completely removed for the target UE (e.g. UE 801). Second, representation of the scheduled resources is simplified by for example using RU IDs. Third, the control message is updated less frequently. The control message is less frequently updated in terms of the MCS update to the target UE. While MCS needs to be updated at each the conventional downlink control message with mini-second interval, there is no MCS updates in the LDCM. Instead, the MCS information can be updated when the LOMA MAP(s) is delivered. The control message is also less frequently updated in terms of SNR information uploads from the UE. The conventional downlink control message uploads the SNR information at mini-second interval via uplink control messages. Only one SNR measurement can be uploaded at the current interval. On the other hand, the LDCM uploads the SNR information to the LOMA controller at a customized frequency. Multiple SNR measurements can be uploaded at the same time via one uplink control message.

FIG. 13 illustrates a procedure 1300 for the LOMA MAP enabled downlink data re-transmission, in accordance with embodiments of the present disclosure. Provided that the downlink LOMA MAP(s) can be stored by both infrastructures and UEs, when downlink packet lost occurs (e.g. RUs lost during the downlink transmission), the UE 801, at step 1310, detects that one or more RUs are lost.

Upon detection that one or more RUs are lost, the UE 801, at step 1320, sends the infrastructure 802 a request for downlink LOMA re-transmission (DLR). The DLR request may include the ID of the UE 801 and the ID of the lost or partially lost packet. When the downlink packet is partially lost, the IDs of lost RUs are also included in the DLR request. When the whole downlink packet is lost, an integer zero (0) or other 1-bit data will be included in the DLR request to indicate that the whole downlink packet is lost.

The infrastructure 802 decodes the DLR request to obtain the content of the DLR request. Once the DLR request content is obtained, the infrastructure 802, at step 1330, schedules new available RUs for re-transmission of the lost data.

When the RU scheduling is complete, the infrastructure 802, at step 1340, sends the LDCM to the UE 801. The LDCM includes the IDs of the re-scheduled RUs (or information indicative of the IDs of the re-scheduled RUs) and retransmission indicator (RI). As stated above, the RI may be an integer indicative of the data transmission type. Specifically, the RI may be set as ‘1’ to indicate that ‘1’ may indicate that the downlink data is retransmitted (i.e. data re-transmission) upon request of the target UE 801.

After transmission of the LDCM, the UE 801 and the infrastructure 802 complete the re-transmission of the lost data. Specifically, the UE 801 and the infrastructure 802 behave in a similar manner to that as defined for steps 1250 to 1280 in the procedure 1200 for the LOMA MAP enabled downlink data transmission.

According to embodiments, as stated above, the RU management AI function (e.g. RU management AI function 714 of FIG. 7) determines the optimal RU types and amounts based on the scheduling algorithm design. As such, the random RU access algorithm can be applied in the LOMA RAN in order to realize the schedule-free uplink data transmission without significantly degrading performance in comparison with the schedule-based uplink data transmission. In some embodiments, for example, a LOMA MAP enabled random RU access algorithm may include the followings:
Each zone associated with a RU set contains multi-type RUs. The shapes, volumes and amounts of the multi-type RUs can be optimized by the RU management AI function;
Upon arrival of the uplink packet, the UE calculates the combination of the RUs needed to carry the data packets in an avaricious manner (i.e. calculate the RU combination such that the data packets are carried using minimal number of RUs); and
The UE randomly selects RUs from the available RU set.

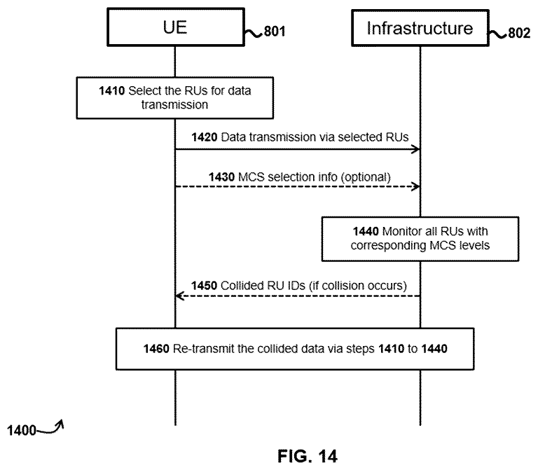

FIG. 14 illustrates a procedure 1400 for the LOMA MAP enabled uplink data transmission in accordance with embodiments of the present disclosure. The procedure 1400 takes the place upon provision of the LOMA MAP enabled random RU access algorithms.

Referring to FIG. 14, upon arrival of the uplink data packet at the UE 801, the UE 801, at step 1410, selects one or more RUs for data transmission according to the LOMA MAP enabled random RU access algorithm. Upon selecting the RUs, at step 1420, the UE 801 transmits the data to the infrastructure 802 (for example a LOMA RAN) via the selected RUs.

For uplink LOMA MAPs organized by two-layer zoning scheme, when two or more MCS levels are available in one SR-region, the UE 801, at step 1430, also transmits the optional MCS selection information with the data payload of each RU, in order to indicate the MCS for decoding the RU. It will be readily understood that steps 1420 and 1430, namely transmitting the data and transmitting the optional MCS selection information, can be performed as a single step.

After the infrastructure 802 receives the data packets from the UE 801, the infrastructure 802, at step 1440, monitors for any resulting collisions between RUs with corresponding MCS levels (MCS selection information), such that for example upon identification of a collision data re-transmission can be initiated.

If collision is detected at specific RUs, the infrastructure 802, at step 1450, broadcasts (or directly sends to the UE 801) the IDs of the collided RU via uplink control channel(s). Then, the corresponding UEs 801, at step 1460, re-transmit the collided data in the similar manner that the data is transmitted via the selected RUs at steps 1410 to 1440.

According to embodiments, the above LOMA MAP enabled unlink data transmission significantly reduces the signal overhead, especially in comparison with the existing schedule based uplink data transmission. The signal overhead can be reduced as the uplink LOMA MAP enabled random RU access has no signal overheads for MCS updates. Further, the signal overhead can be also reduced as the uplink LOMA MAP enabled random RU access has a simplified uplink resource scheduling and simplified spectrum resource representation (e.g. RU IDs). The simplified uplink resource scheduling implies that there is no need for the uplink transmission request message or scheduled resource indicating message. The simplified uplink resource scheduling also implies there is no complex uplink scheduling algorithm executed by infrastructure.

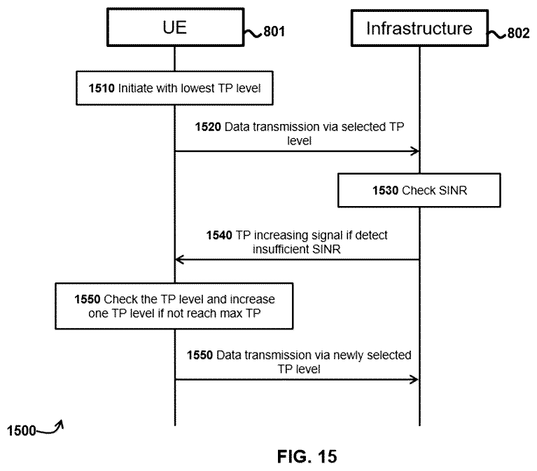

According to embodiments, UEs in one Zone may adjust their TP levels within the TP range associated with that Zone, in order to keep the TP levels aligned with the associated MCS level. In order to determine the appropriate TP or TP levels, a procedure for exchanging TP control information between the UE and the infrastructure is defined as illustrated in FIG. 15. FIG. 15 illustrates the TP control procedure 1500 for LOMA MAP enabled uplink data transmission, in accordance with embodiments of the present disclosure.

Referring to FIG. 15, the UE 801, at step 1510, initially uses the lowest TP level in the TP range associated with the Zone in which the UE 801 is located.

At step 1520, the UE 801 performs uplink data transmission. The uplink data is transmitted to the infrastructure 802 via the selected TP level.

The infrastructure 802, at step 1530, checks SINR. If the infrastructure 802 detects insufficient SINR to maintain corresponding MCS for said Zone, the infrastructure 802, at step 1540, sends a TP increasing signal via uplink control channel. The TP increasing signal can be as short as 1 bit for the purpose of indicating that one TP level increase is needed in the TP range.

Upon receiving the TP increasing signal, the UE 801, at step 1550, checks whether its TP level reaches the maximum TP defined in the TP range. If the TP level is not the maximum TP defined in the TP range, UE 801, at step 1550, increases one TP level (i.e. increase the TP level by one level). At step 1560, the UE 801 conducts uplink data transmission via the newly selected TP level.

Through the TP control procedure 1500, all UEs 801 covered by the infrastructure 802 can converge to the appropriate TP level thereby aligning with the associated MCS level.

According to embodiments, the AI enabled multi-layer LOMA MAP illustrated in the present disclosure can be directly applied to various types of services such as industrial internet-of-things (IIoT), sensor networks, industrial automation among other services. These types of services are usually associated with a large number of fixed or regularly moving network entities in bursty network traffic conditions. Real-time scheduler based multiple access can face challenges especially in bursty traffic scenarios with a large number of network devices. Moreover, the static network devices or highly mobile network devices need to ensure stable wireless channel states. The AI enabled multi-layer LOMA MAP can achieve highly precise resource allocation without frequent updates.

According to embodiments, the AI enabled LOMA MAP can be used to realize spectrum planning in network scenarios that cannot be addressed by traditional methods. Such network scenarios may include network scenarios where network entities are irregularly deployed.

According to embodiments, the AI enabled LOMA MAP concept can be applied in a variety of radio access networks, such as internet-of-things (IoT) networks, vehicular networks and satellite networks, as long as there exists some form of correlation between RAN parameters (or some of the RAN parameters) and locations of the UEs or infrastructures within the RAN.

According to embodiments, the dynamic RU concept can be extended to a variety of types of network resources including communication resources, computing resources, caching resources, energy consumptions, etc.

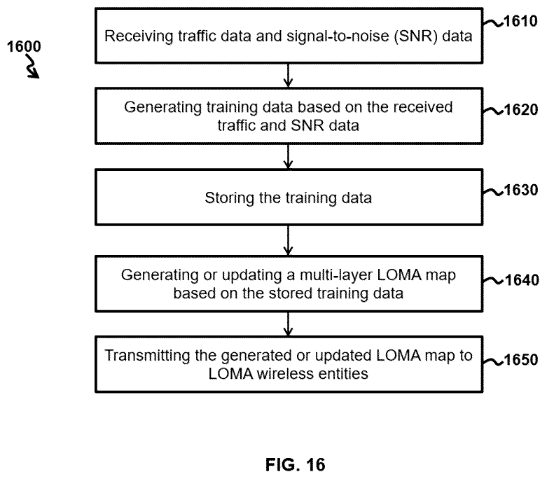

FIG. 16 illustrates a method 1600 for managing network resources for data transmission in a location based multiple access (LOMA) radio access network (RAN), in accordance with embodiments of the present disclosure. The method includes receiving 1610 traffic data and signal-to-noise (SNR) data from one or more the LOMA wireless entities. The method 1600 further includes generating 1620 training data based on the received traffic and signal-to-noise ratio (SNR) data, and storing 1630 the generated training data. The method 1600 further includes generating 1640 a multi-layer LOMA map based on the stored training data, or, if there is an existing multi-layer LOMA map, the step 1640 includes updating the existing multi-layer LOMA map. The multi-layer LOMA map has an upper layer and a lower layer, where the upper layer includes one or more LOMA upper layer zones and the lower layer includes one or more LOMA lower layer zones. Each LOMA upper layer zone is associated with some of the one or more LOMA lower layer zones. The method 1600 further includes transmitting 1650 the generated or updated LOMA map to the one or more LOMA wireless entities.

In some embodiments, each LOMA upper-layer zone and each LOMA lower-layer zone are associated with one or more LOMA parameters, respectively. The one or more LOMA parameters associated with the LOMA upper-layer zone may be sharable with at least some of the one or more LOMA lower layer zones that are associated with the LOMA upper-layer zone. The one or more LOMA parameters may include one or more of allocated radio resource information, modulation and coding scheme (MCS) information, transmit power (TP) information and beam information.

In some embodiments, each LOMA upper-layer zone and each LOMA lower-layer zone include one or more LOMA tiles, respectively, the one or more LOMA tiles covering the geographic area of the LOMA RAN without gap or overlap. In some embodiments, a radio resource set is allocated to a LOMA upper-layer zone based on one or more of network data traffic distributions and wireless channel states, the radio resource set allocated to the LOMA upper-layer zone sharable with at least some of the one or more LOMA lower layer zones that are associated with said LOMA upper layer zone.

In some embodiments, the method 1600 further includes monitoring if variation of the stored traffic and channel state distribution dataset exceeds a predetermined threshold. If the variation exceeds the predetermined threshold, the method 1600 further includes initiating generating or updating the multi-layer LOMA map.

In some embodiments, the training data includes uplink/downlink channel state distribution data, uplink/downlink spatial traffic distribution data and uplink/downlink temporal traffic distribution data. In such embodiments, generating or updating 1640 a multi-layer LOMA map includes determining the size and shape of each LOMA upper layer zone and LOMA parameters associated with each LOMA upper layer zone based on the uplink/downlink channel state distribution data and the uplink/downlink spatial traffic distribution data. Generating or updating 1640 a multi-layer LOMA map further includes determining the size and shape of each LOMA lower layer zone and LOMA parameters associated with each LOMA lower layer zone based on the uplink/downlink channel state distribution data, the uplink/downlink spatial traffic distribution data, the determined size and shape of each LOMA upper layer zone, and the determined LOMA parameters associated with each LOMA upper layer zone. Generating or updating 1640 a multi-layer LOMA map further includes determining types and amounts of resource units (RUs) based on the determined size and shape of each LOMA upper layer zone, the determined size and shape of each LOMA lower layer zone, the determined LOMA parameters associated with each LOMA upper layer zone, the determined LOMA parameters associated with each LOMA lower layer zone, and the uplink/downlink temporal traffic distribution data. Generating or updating 1640 a multi-layer LOMA map further includes generating or updating the multi-layer LOMA map based on the RU types and amounts. Each RU may be defined in three-dimensions in terms of transmit power (TP), bandwidth and time-interval.

In some embodiments, determining types and amounts of RUs includes determining intermediate RU types and amounts based on performance feedback of a predetermined RU scheduling algorithm, a predetermined RU access algorithm or both. Determining types and amounts of RUs further includes determining the RU types and amounts based further on the intermediate RU types and amounts.

In some embodiments, the one or more LOMA wireless entities locally stores the LOMA MAP transmitted thereto.

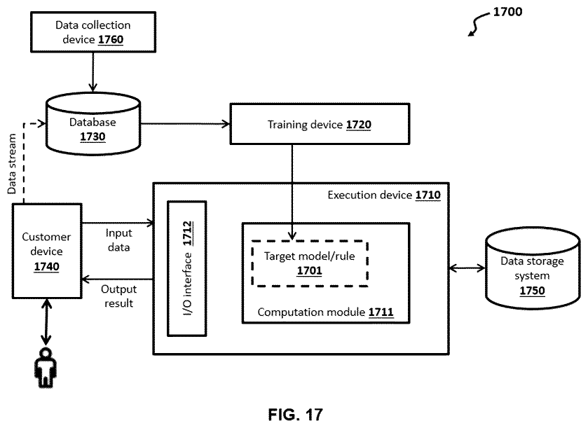

FIG. 17 is a schematic structural diagram of a system architecture 1700 according to an embodiment of the present disclosure. Referring to FIG. 17, an embodiment of the present disclosure provides a system architecture 1700. A data collection device 1760 is configured to collect various data (e.g. traffic data and signal-to-noise (SNR) data) and store the collected data into a database 1730. A training device 1700 may generate a target model/rule 1701 based on the data maintained in the database 1730.

The target model/rule 1701 may refer to desired or pre-trained policy (e.g. predetermined RU scheduling algorithm, a predetermined RU access algorithm) having applied the training embodiments described herein. Accordingly, the training device 1720 may perform the policy training. The following describes in more detail how the training device 1720 obtains the target model/rule 1701 (e.g. predetermined RU scheduling algorithm, a predetermined RU access algorithm) based on the collected environment data that is contained in the database 1730. It should be noted that the one or more methods described herein may be processed by a CPU, or may be jointly processed by a central processing unit (CPU) and a graphics processing unit (GPU), or may not be processed by a GPU, but processed by another processor that is applicable to neural network computation. This is not limited in the instant application.

Work at each layer of a deep neural network may be described by using a mathematical expression \vec{y}=a(W□\vec{x}+b): From a physical perspective, the work at each layer of the deep neural network can be understood as performing five operations on input space (a set of input vectors), to complete a conversion from the input space into output space (in other words, from row space to column space of a matrix). The five operations include: 1. Dimensionality increase/reduction; 2. zooming in/out; 3. rotation; 4. panning; and 5. “bending”. The operations 1, 2, and 3 are performed by W□\vec{x}, the operation 4 is performed by +b, and the operation 5 is implemented by a( ). Herein, a reason why the word “space” is used for description is that objects to be classified are not single matters, but are a type of matters. The space indicates a set of all individuals in this type of matters. W denotes a weight vector. Each value in the vector indicates a weight value of one neural cell at the layer of neural network. The vector W decides the foregoing spatial conversion from the input space to the output space. In other words, the weight W of each layer controls how to convert space. A purpose of training the deep neural network is to finally obtain a weight matrix (a weight matrix consisting of vectors W of a plurality of layers) of all layers of the trained neural network. Therefore, in essence, the training process of the neural network is learning a manner of controlling spatial conversion, and more specifically, learning a weight matrix.

To enable the deep neural network to output a predicted value that is as close to a truly desired value as possible, a predicted value of a current network and a truly desired target value may be compared, and a weight vector of each layer of the neural network is updated based on a difference between the predicted value and the truly desired target value, wherein it will be understood that there is usually an initialization process before a first update. For example, a parameter is preconfigured for each layer of the deep neural network. For example, if the predicted value of a network is excessively high, continuously adjust a weight vector to lower the predicted value, until the neural network can predict the truly desired target value. Therefore, “how to compare a difference between a predicted value and a target value” needs to be predefined. To be specific, a loss function or an objective function needs to be predefined. The loss function and the objective function are important equations used to measure the difference between a predicted value and a target value. For example, the loss function is used as an example. A higher output value (loss) of the loss function indicates a greater difference. In this case, training the deep neural network is a process of minimizing the loss.

The target module/rule (e.g. desired policy) obtained by the training device 1720 may be applied to different systems or devices. In FIG. 17, an execution device 1710 is provided with an I/O interface 1712 to perform data interaction with an external device. A “user” may input data to the I/O interface 1712 by using a customer device 1740.

The execution device 1710 may invoke data, code, and the like from a data storage system 1750, and may store the data, an instruction, and the like into the data storage system 1750.

A computation module 1711 processes the input data by using the target model/rule 1701.

Finally, the I/O interface 1712 returns a processing result to the customer device 1740 and provides the processing result to the user. More deeply, the training device 1720 may generate corresponding target models/rules 1701 for different targets based on different data, to provide a better result for the user. The corresponding target model/rule 1701 may be used to implement the foregoing desired policy to provide a desired result for the user.

In a case shown in FIG. 17, the user may manually specify data to be input to the execution device 1710, for example, an operation in a screen provided by the I/O interface 1712. In another case, the customer device 1740 may automatically input data to the I/O interface 1712 and obtain a result. If the customer device 1740 automatically inputs data, authorization of the user needs to be obtained. The user can specify a corresponding permission in the customer device 1740. The user may view, in the customer device 1740, the result output by the execution device 1710. A specific presentation form may be display content, a voice, an action, and the like. In addition, the customer device 1740 may be used as a data collector to store collected data into the database 1730.

It should be noted that FIG. 17 is merely a schematic diagram of a system architecture according to an embodiment of the present disclosure. Position relationships between the device, the component, the module, and the like that are shown in FIG. 17 do not constitute any limitation. For example, in FIG. 17, the data storage system 1750 is an external memory relative to the execution device 1710. In another case, the data storage system 1750 may be located in the execution device 1710.

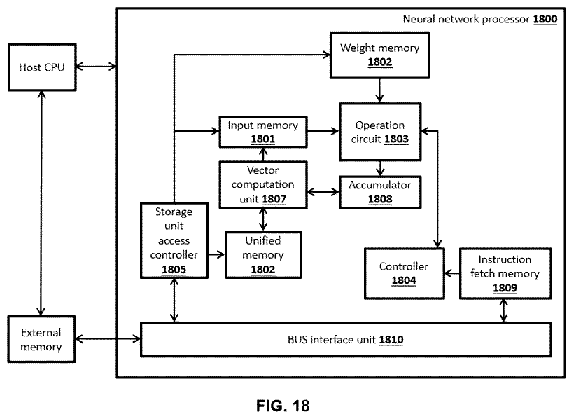

FIG. 18 is a structural hardware diagram of a chip according to an embodiment of the present disclosure. The chip includes a neural network processor 1800. The chip may be provided in the execution device 1710 shown in FIG. 17, to perform computation for the computation module 1711. Alternatively, the chip may be provided in the training device 1720 shown in FIG. 17, to perform training and output the target model/rule 1701.

The neural network processor 1800 may be any processor that is applicable to massive exclusive OR operations, for example, a neural processing unit (NPU), a tensor processing unit (TPU), a graphics processing unit (GPU), or the like. An NPU is used as an example. The NPU may be mounted, as a coprocessor, to a host CPU, and the host CPU allocates a task. A core part of the NPU is an operation circuit 1803. A controller 1804 controls the operation circuit 1803 to extract matrix data from a memory and perform a multiplication operation.

In some implementations, the operation circuit 1803 internally includes a plurality of processing units (process engine, PE). In some implementations, the operation circuit 1803 is a bi-dimensional systolic array. In addition, the operation circuit 1803 may be a uni-dimensional systolic array or another electronic circuit that can implement a mathematical operation such as multiplication and addition. In some implementations, the operation circuit 1803 is a general matrix processor.

For example, it is assumed that there are an input matrix A, a weight matrix B, and an output matrix C. The operation circuit obtains, from a weight memory 1802, data corresponding to the matrix B, and caches the data in each PE in the operation circuit. The operation circuit obtains data of the matrix A from an input memory 1801, and performs a matrix operation on the data of the matrix A and the data of the matrix B. An obtained partial or final matrix result is stored in an accumulator (accumulator) 1808.

A unified memory 1806 is configured to store input data and output data. Weight data is directly moved to the weight memory 1802 by using a storage unit access controller (e.g. direct memory access controller, DMAC) 1805. The input data is also moved to the unified memory 1806 by using the DMAC.

A bus interface unit (BIU) 1810 is configured to enable an advanced extensible interface (AXI) bus to interact with the DMAC and an instruction fetch memory (instruction fetch buffer) 1809. The BIU 1810 may be further configured to enable the instruction fetch memory 1809 to obtain an instruction from an external memory, and is further configured to enable the storage unit access controller 1805 to obtain, from the external memory, source data of the input matrix A or the weight matrix B.

The storage unit access controller (e.g., DMAC) 1805 is mainly configured to move input data from an external memory double data rate (DDR) to the unified memory 1806, or move the weight data to the weight memory 1802, or move the input data to the input memory 1801.

A vector computation unit 1807 includes a plurality of operation processing units. If needed, the vector computation unit 1807 performs further processing, for example, vector multiplication, vector addition, an exponent operation, a logarithm operation, or magnitude comparison, on an output from the operation circuit. The vector computation unit 1807 is mainly used for non-convolutional/FC-layer network computation in a neural network, for example, pooling, batch normalization, or local response normalization.

In some implementations, the vector computation unit 1807 can store, to the unified buffer 1806, a vector output through processing. For example, the vector computation unit 1807 may apply a nonlinear function to an output of the operation circuit 1803, for example, a vector of an accumulated value, to generate an activation value. In some implementations, the vector computation unit 1807 generates a normalized value, a combined value, or both a normalized value and a combined value. In some implementations, the vector output through processing (the vector processed by the vector computation unit 1807) may be used as activation input to the operation circuit 1803, for example, to be used in a some layer(s) of the recurrent neural network in FIG. 17.

The instruction fetch memory (instruction fetch buffer) 1809 connected to the controller 1804 is configured to store an instruction used by the controller 1804. The unified memory 1806, the input memory 1801, the weight memory 1802, and the instruction fetch memory 1809 are all on-chip memories. The external memory is independent from the hardware architecture of the NPU.

Operations at the layers of the recurrent neural networks, for example RNN shown in FIG. 17 may be performed by the operation circuit 1803 or the vector computation unit 1807.

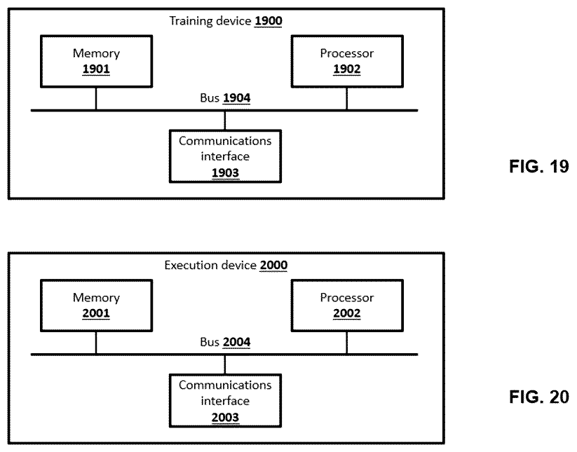

FIG. 19 is a schematic diagram of a hardware structure of a training apparatus according to an embodiment of the present disclosure. A training apparatus 1900 shown in FIG. 19 includes a memory 1901, a processor 1902, a communications interface 1903, and a bus 1904. A communication connection is implemented between the memory 1901, the processor 1902, and the communications interface 1903 by using the bus 1904. The apparatus 1900 may be specifically a computer device and may refer to the training device 1720.

The memory 1901 may be a read-only memory (ROM), a static storage device, a dynamic storage device, or a random access memory (RAM). The memory 1901 may store a program. The processor 1902 and the communications interface 1903 are configured to perform, when the program stored in the memory 1901 is executed by the processor 1902, steps of one or more embodiments described herein.

The processor 1902 may be a general central processing unit (CPU), a microprocessor, an application-specific integrated circuit (ASIC), a graphics processing unit (GPU), or one or more integrated circuits. The processor 1902 may be configured to execute a related program to implement a function that needs to be performed by a unit in the training apparatus according to one or more embodiments described herein.

In addition, the processor 1902 may be an integrated circuit chip with a signal processing capability. In an implementation process, steps of the training method according to this application may be performed by an integrated logical circuit in a form of hardware or by an instruction in a form of software in the processor 1902. In addition, the foregoing processor 1902 may be a general purpose processor, a digital signal processor (digital signal processor, DSP), an application-specific integrated circuit (ASIC), a field programmable gate array (FPGA) or another programmable logic device, a discrete gate or a transistor logic device, or a discrete hardware assembly. The processor 1902 may implement or execute the methods, steps, and logical block diagrams that are disclosed in the embodiments of this application. The general purpose processor may be a microprocessor, or the processor may be any conventional processor or the like. The steps of the method disclosed with reference to the embodiments of this application may be directly performed by a hardware decoding processor, or may be performed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory 1901. The processor 1902 reads information from the memory 1901, and completes, by using hardware in the processor 1902, the functions that need to be performed by the units included in the training apparatus according to one or more embodiments described herein.

The communications interface 1903 implements communication between the apparatus 1900 and another device or communications network by using a transceiver apparatus, for example, including but not limited to a transceiver. For example, training data (for example, training data based on the received traffic and signal-to-noise ratio (SNR) data obtained from the LOMA wireless entities) may be obtained by using the communications interface 1903.

The bus 1904 may include a path that transfers information between all the components (for example, the memory 1901, the processor 1902, and the communications interface 1903) of the apparatus 1900.

FIG. 20 is a schematic diagram of a hardware structure of an execution apparatus according to an embodiment of the present disclosure. An execution apparatus 2000 shown in FIG. 20 includes a memory 2001, a processor 2002, a communications interface 2003, and a bus 2004. A communication connection is implemented between the memory 2001, the processor 2002, and the communications interface 2003 by using the bus 2004. The apparatus 2000 may be specifically a computer device or refer to the execution device 1710.

The memory 2001 may be a read-only memory (ROM), a static storage device, a dynamic storage device, or a random access memory (RAM). The memory 2001 may store a program. The processor 2001 and the communications interface 2002 are configured to perform, when the program stored in the memory 2002 is executed by the processor 2003, steps of one or more embodiments described herein.

The processor 2002 may be a general central processing unit (CPU), a microprocessor, an application-specific integrated circuit (ASIC), a graphics processing unit (GPU), or one or more integrated circuits. The processor 2002 may be configured to execute a related program to implement a function that needs to be performed by a unit in the execution apparatus according to one or more embodiments described herein.

In addition, the processor 2002 may be an integrated circuit chip with a signal processing capability. In an implementation process, steps of one or more execution methods described in the present disclosure may be performed by an integrated logical circuit in a form of hardware or by an instruction in a form of software in the processor 2002. In addition, the foregoing processor 2002 may be a general purpose processor, a digital signal processor (DSP), an application-specific integrated circuit (ASIC), a field programmable gate array (FPGA) or another programmable logic device, a discrete gate or a transistor logic device, or a discrete hardware assembly. The foregoing processor 2002 may implement or execute the methods, steps, and logical block diagrams that are disclosed in the embodiments of this application. The general purpose processor may be a microprocessor, or the processor may be any conventional processor or the like. The steps of the method disclosed with reference to the embodiments of this application may be directly performed by a hardware decoding processor, or may be performed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory 2001. The processor 2002 reads information from the memory 2001, and completes, by using hardware in the processor 2002, the functions that need to be performed by the units included in the execution apparatus according to one or more embodiments described herein.

The communications interface 2003 implements communication between the apparatus 2000 and another device or communications network by using a transceiver apparatus, for example, including but not limited to a transceiver. For example, training data may be obtained by using the communications interface 2003.

The bus 2004 may include a path that transfers information between all the components (for example, the memory 2001, the processor 2002, and the communications interface 2003) of the apparatus 2000.

It should be noted that, although only the memory, the processor, and the communications interface are shown in the apparatuses 1900 and 2000 in FIG. 19 and FIG. 20, in a specific implementation process, a person skilled in the art should understand that the apparatuses 1900 and 2000 may further include other components that are necessary for implementing normal running. In addition, based on specific needs, a person skilled in the art should understand that the apparatuses 1900 and 2000 may further include hardware components that implement other additional functions. In addition, a person skilled in the art should understand that the apparatuses 1900 and 2000 may include only a component required for implementing the embodiments of the present disclosure, without a need to include all the components shown in FIG. 19 or FIG. 20.

It may be understood that the apparatus 1900 is equivalent to the training device 1700 in FIG. 17, and the apparatus 2000 is equivalent to the execution device 1710 in FIG. 17. A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

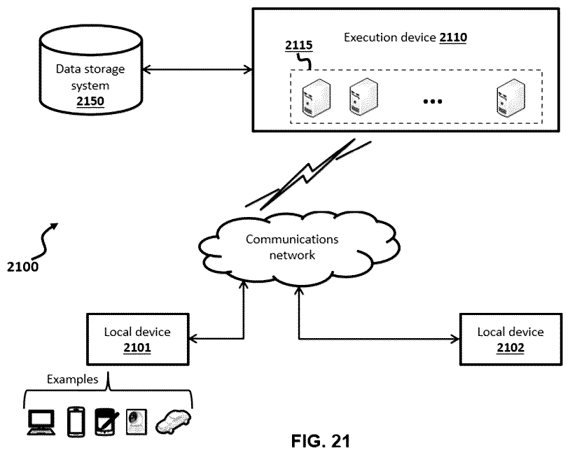

FIG. 21 illustrates a system architecture 2100 according to an embodiment of the present disclosure. Referring to FIG. 21, an embodiment of the present disclosure provides a system architecture 2100. An execution device 2110 is implemented by one or more servers 2115, and optionally, supported by another computation device, for example, a data memory, a router, a load balancer, or another device. The execution device 2110 may be arranged in a physical station or be distributed to a plurality of physical stations. The execution device 2110 may use data in a data storage system 2150 or invoke program code in a data storage system 2150, to implement steps of the method disclosed with reference to the embodiments of this application.

Users may operate respective user equipment (such as a local device 2101 and another local device 2102) of the users to interact with the execution device 2110. Each local device may indicate any computation device, for example, a personal computer, a computer work station, a smartphone, a tablet computer, a smart camera, a smart car, or another type of cellular phone, a media consumption device, a wearable device, a set-top box, or a game console.

The local device of each user may interact with the execution device 2110 by using a communications network of any communications mechanism/communications standard. The communications network may be a wide area network, a local area network, a point-to-point connected network, or any combination thereof.

In another implementation, one or more aspects of the execution devices 2110 may be implemented by each local device. For example, the local device 2101 may provide local data for the execution device 2110 or feedback a computation result.

It should be noted that all functionalities of the execution device 2110 may be implemented by the local device. For example, the local device 2101 implements a function of the execution device 2110 and provides a service for a user of the local device 2101, or provides a service for a user of the local device 2102.

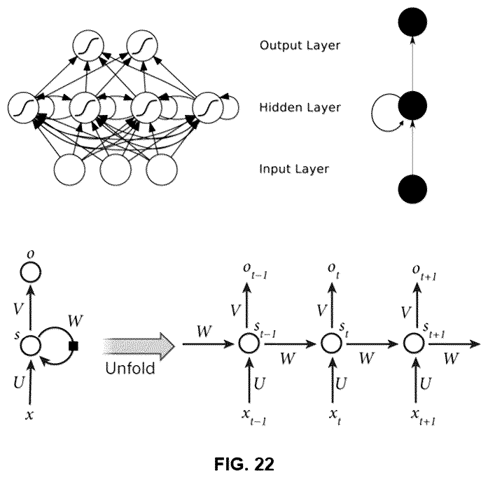

FIG. 22 is a schematic structural diagram of an RNN according to embodiments of the present disclosure. RNNs are to process sequence data. In a conventional neural network model, a full connection is implemented between layers, from an input layer to a hidden layer and then to an output layer, and nodes between layers are disconnected. However, such a common neural network is incapable of resolving many problems. For example, to predict a word in a sentence, a previous word is usually needed, because a word is dependent on its previous word in a sentence. RNNs are referred to as recurrent neural networks, because a current output of a sequence is also related to a previous output. In a specific representation form, a network memorizes previous information and applies the previous information to computation of the current output. In other words, the nodes between the hidden layers are no longer disconnected, but are connected, and an input to a hidden layer not only includes an output from the input layer, but also includes an output from the hidden layer at a previous moment. In theory, the RNNs can process sequence data of any length.

Training of the RNN is the same as training of a conventional artificial neural network (ANN). The BP error back propagation algorithm is also used. However, there is a difference. If the RNNs are unfolded, parameters W, U, and V are shared. However, the parameters are not shared in a conventional neural network. In addition, in a gradient descent algorithm, an output of each step not only depends on a network of a current step, but also depends on network states of several previous steps. For example, when t is 4, the propagation needs to be performed backward for three additional steps, and respective gradients need to be added to each of the three steps. The learning algorithm is referred to as back propagation through time (BPTT).

The recurrent neural network is needed in spite of the existing artificial neural network and the existing convolutional neural network. A premise of the convolutional neural network and a premise of the artificial neural network are both as follows: Elements are mutually independent, and an input is independent from an output. However, in the real world, many elements are mutually connected, and inputs are often affected by outputs. Therefore, to overcome the gap between the real world and the premise of existing convolutional neural network and artificial neural network, the present recurrent neural network emerges. The essence of the recurrent neural network is that the recurrent neural network has a memorizing capability, just like a human being does. In this way, an output of the recurrent neural network depends on a current input and a memory.

Referring to FIG. 22 illustrating a structure of an RNN, each circle may be considered as one cell, and each cell does a same thing. Therefore, the diagram may be folded into a half figure on the left. In a word, the RNN is obtained through repeated use of one cell structure.

The RNN is a sequence-to-sequence model. It is assumed that xₜ₋₁, xₜ, and xₜ₊₁ are inputs: “United States of”. In this case, oₜ₋₁ and oₜ are corresponding to “States” and “of” respectively. Upon prediction of the next word, there is a relatively high probability that oₜ₊₁ is “America”.

Therefore, the followings can be defined:

Xₜ indicates an input at a t moment, or indicates an output at the t moment, and Sₜ indicates a memory at the t moment. An output at a current moment is determined based on an output at the current moment and a memory. A neural network is best at integrating a large amount of content by using a series of parameters and then learning the parameters. In this way, a base of the RNN is defined as follows:

$${S}_{t} = f ( U * {X}_{t} + W * {S}_{t} - 1 )$$

The f( ) function is an activation function in the neural network. Since the RNN is capable of memorizing, certainly, only important information is memorized, other unimportant information can be surely forgotten. For that, an activation function is needed for filtering information in the neural network. Therefore, an activation function is applied herein, to make a non-linear mapping to filter information. This activation function may be tanh or may be another function.

An idea of the RNN can be to make a prediction based on the memory Sₜ at the current moment. When a next word for “United States of” is predicted, it is apparent that the next word would be “America”. In practice, such predictions will be made using softmax to ensure the next word is most appropriate and probable word to be placed. However, it should be noted that as a matrix cannot be directly used to make such prediction, a weight matrix V needs to be utilized when making the prediction. The weight matrix is indicated by the following formula:

$${o}_{t} = soft max ( {VS}_{t} ) ,$$

where oₜ indicates the output at the t moment.

The following considerations can be applicable.
1. Sₜ may be considered as a hidden state in which information at a previous time point is captured;
2. oₜ is obtained based on all memories at current time and previous time;
3. However, not information at all previous time points can be captured in Sₜ;
4. Like a convolutional neural network, in a RNN network, all cells share a group of parameters (U, V, and W). This can greatly reduce a computation amount; and
5. oₜ is nonexistent in a large quantity of cases, because only a final result is concerned in a large quantity of tasks, such as a text sentiment analysis.

It will be readily understood that the expression A/B is used to define the alternative or sum of both. For example, A/B can be interpreted as A or B. As another example, A/B can be interpreted as A and B. It will be readily understood that A and B are merely used as a place holder for different words. For example, in the instant application “A” has been replaced by “uplink” and “B” has been replaced by “downlink”. Other words or terms may replace one or both of A and B.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the present disclosure are examples and can be varied in many ways. Such present or future variations are not to be regarded as a departure from the spirit and scope of the present disclosure, and all such modifications as would be obvious to one skilled in the art are intended to be included within the scope of the following claims.

1. A method for managing network resources for data transmission, the method comprising:
receiving traffic data and signal-to-noise (SNR) data from one or more wireless entities associated with a location based multiple access (LOMA) radio access network (RAN);
generating training data based on the received traffic data and SNR data;
generating or updating a multi-layer LOMA map based on the training data, the multi-layer LOMA map including multiple layers, each layer including one or more LOMA zones, and, each LOMA zone in an upper layer of the multi-layer LOMA map associated with one or more LOMA zones in a lower layer of the multi-layer LOMA map; and
transmitting the generated or updated multi-layer LOMA map to the one or more wireless entities.

2. The method of claim 1, wherein each LOMA zone is associated with one or more LOMA parameters.

3. The method of claim 2, wherein the one or more LOMA parameters associated with a LOMA zone in an upper layer of the multi-layer LOMA map are sharable with one or more LOMA zones in a lower layer of the multi-layer LOMA map.

4. The method of claim 2, wherein the one or more LOMA parameters include one or more of allocated radio resource information, modulation and coding scheme (MCS) information, transmit power (TP) information and beam information.

5. The method of claim 1, wherein each LOMA zone includes one or more LOMA tiles, the one or more LOMA tiles are configured to cover a geographic area of the LOMA RAN without gaps or overlap.

6. The method of claim 1, wherein a radio resource set is allocated to a particular LOMA zone based on one or more of network data traffic distributions and wireless channel states, wherein the radio resource set allocated to a LOMA zone in an upper layer of the multi-layer LOMA map is sharable with one or more LOMA zones which are in a lower layer of the multi-layer LOMA map and are associated with LOMA zone in the upper layer.

7. The method of claim 1, further comprising:
monitoring for a variation of the training data indicative of traffic data and a channel state distribution dataset; and
if the variation exceeds a predetermined threshold, initiating to update the multi-layer LOMA map.

8. The method of claim 1, wherein the training data includes uplink or downlink channel state distribution data, uplink or downlink spatial traffic distribution data, and uplink or downlink temporal traffic distribution data.

9. The method of claim 8, wherein before generating or updating the multi-layer LOMA map, the method further comprises:
determining a size and a shape of each LOMA zone in an upper layer and LOMA parameters associated with each LOMA zone in the upper layer based on the uplink or downlink channel state distribution data and the uplink or downlink spatial traffic distribution data; and
determining a size and a shape of each LOMA zone in a lower layer and LOMA parameters associated with each LOMA zone in the lower layer based on the uplink or downlink channel state distribution data, the uplink or downlink spatial traffic distribution data, the determined size and shape of each LOMA zone in the upper layer, and the determined LOMA parameters associated with each LOMA zone in the upper layer; and
determining types and amounts of resource units (RUs) based on the determined size and shape of each LOMA zone, the determined LOMA parameters associated with each LOMA zone, and the uplink or downlink temporal traffic distribution data;
wherein the generating or updating the multi-layer LOMA map is based on the RU types and amounts.

10. The method of claim 9, wherein each RU is defined in three-dimensions including transmit power (TP), bandwidth and time-interval.

11. The method of claim 9, wherein the determining types and amounts of RUs comprises:
determining intermediate RU types and amounts based on performance feedback of one or more of a predetermined RU scheduling algorithm and a predetermined RU access algorithm; and
determining the RU types and amounts based further on the intermediate RU types and amounts.

12. The method of claim 1, wherein the multi-layer LOMA map is locally stored in the one or more wireless entities.

13. A method for uplink data transmission, the method comprising:
selecting, by a user equipment (UE), one or more resource units (RUs) for data transmission at least in part based on a multi-layer location based multiple access (LOMA) map, the multi-layer LOMA map at least in part defining a modulation and coding scheme (MCS) associated with the UE; and
transmitting, by the UE, uplink data using the one or more selected RUs.

14. The method of claim 13, further comprising:
receiving, by the user equipment (UE), an identifier associated with the uplink data transmission, the identifier indicative of a desired retransmission of the uplink data.

15. The method of claim 13, wherein when two or more MCSs are associated with the UE, the method further comprises a selection of the MCS from the two or more MCSs.

16. An apparatus comprising one or more processors coupled with a memory storing instructions which when executed by the one or more processors cause the apparatus to:
receive traffic data and signal-to-noise (SNR) data from one or more wireless entities associated with a location based multiple access (LOMA) radio access network (RAN);
generate training data based on the received traffic data and SNR data;
generate or update a multi-layer LOMA map based on the training data, the multi-layer LOMA map including multiple layers, each layer including one or more LOMA zones, and, each LOMA zone in an upper layer of the multi-layer LOMA map associated with one or more LOMA zones in a lower layer of the multi-layer LOMA map; and
transmit the generated or updated multi-layer LOMA map to the one or more wireless entities.

17. An apparatus comprising one or more processors coupled with a memory storing instructions which when executed by the one or more processors cause the apparatus to:
select one or more resource units (RUs) for data transmission at least in part based on a multi-layer location based multiple access (LOMA) map, the multi-layer LOMA map at least in part defining a modulation and coding scheme (MCS) associated with the apparatus; and
transmit uplink data using the one or more selected RUs.

18. The apparatus of claim 17, wherein the instructions when executed by the one or more processors cause the apparatus to:
receive an identifier associated with uplink data transmission, the identifier indicative of a desired retransmission of the uplink data.

19. A communication system comprising an apparatus and one or more wireless entities, wherein
the apparatus is configured to:
receive traffic data and signal-to-noise (SNR) data from the one or more wireless entities associated with a location based multiple access (LOMA) radio access network (RAN);
generate training data based on the received traffic data and SNR data;
generate or update a multi-layer LOMA map based on the training data, the multi-layer LOMA map including multiple layers, each layer including one or more LOMA zones, and, each LOMA zone in an upper layer of the multi-layer LOMA map associated with one or more LOMA zones in a lower layer of the multi-layer LOMA map; and
transmit the generated or updated multi-layer LOMA map to the one or more wireless entities; and
the one or more wireless entities are configured to:
transmit the traffic data and SNR data; and
receive the generated or updated multi-layer LOMA map.

20. The communication system of claim 19, wherein at least one wireless entity of the one or more wireless entities is configured to:
select one or more resource units (RUs) for data transmission at least in part based on the LOMA map, the multi-layer LOMA map at least in part defining a modulation and coding scheme (MCS) associated with the at least one wireless entity; and
transmit uplink data using the one or more selected RUs.
